(19) United States
(12) Patent Application Publication
(10) Pub. No.: US 2003/0113665 A1
(43) Pub. Date: Jun. 19, 2003

(54) Optical data medium containing, in the information layer, a dye as a light-absorbing compound

(76) Inventors: Horst Berneth, Leverkusen (DE); Friedrich-Karl Bruder, Krefeld (DE); Wilfried Haese, Odenthal (DE); Rainer Hagen, Leverkusen (DE); Karin Hassenruck, Dusseldorf (DE); Serguei Kostromine, Swisttal (DE); Peter Landenberger, Koln (DE); Rafael Oser, Krefeld (DE); Thomas Sommermann, Bergisch Gladbach (DE); Josef-Walter Stawitz, Odenthal (DE); Thomas Bieringer, Odenthal (DE); Yuichi Sabi, Tokyo (JP); Sakuya Tamada, Tokyo (JP); Masanobu Yamamoto, Yokohama (JP)

Correspondence Address: BAYER CORPORATION, PATENT DEPARTMENT, 100 BAYER ROAD, PITTSBURGH, PA, 15205, US

(21) Appl. No.: 10/101,792

(22) Filed: Mar. 20, 2002

(30) Foreign Application Priority Data
Mar. 28, 2001 (DE) 10115227.2
Apr. 6, 2001 (DE) 10117461.6
Apr. 6, 2001 (DE) 10117462.4
Apr. 6, 2001 (DE) 10117463.2
Apr. 6, 2001 (DE) 10117464.0
May 21, 2001 (DE) 10124585.8
Jul. 25, 2001 (DE) 10136064.9
Jul. 25, 2001 (DE) 10136063.0
Aug. 22, 2001 (DE) 10140165.5
Oct. 4, 2001 (EP) 01123810.2
Dec. 21, 2001 (DE) 01130527.3
Jan. 9, 2002 (DE) 10200484.6
Jan. 24, 2002 (DE) 1020257.1
Mar. 11, 2002 (EP) 02005505.9

(51) Int. Cl. G11B 7/26

(52) U.S. Cl. 430/270.16; 369/283; 430/945; 428/64.6; 428/64.8; 430/270.17; 430/270.18

(57) ABSTRACT

Optical data medium containing a preferably transparent substrate which is optionally already coated with one or more barrier layers and on the surface of which an information layer which can be recorded on using light, optionally one or more barrier layers, and a cover layer, have been applied, which data medium can be recorded on and read using focused blue light through the cover layer on the information layer, preferably laser light with the wavelength between 360 nm and 460 nm, the information layer containing a light-absorbing compound and optionally a binder, characterized in that at least one dye is used as the light-absorbing compound wherein the cover layer on the top of the information layer including the adhesive layer do have a total thickness of 10 μm to 177 μm and the numerical aperture NA of the focusing objective lens setup is greater or equal 0.8.

### PRIOR ART

The invention relates to a, preferably singly recordable, optical data medium which contains, in the information layer, at least one dye as a light-absorbing compound, and has a defined thickness of all the cover layers and can be recorded and readout with a focusing optical setup with a defined numerical aperture and a process for its production.

“The term” singly recordable” has the same meaning as the term “once recordable”.

The singly recordable optical data media using special light-absorbing substances or mixtures thereof are suitable in particular for use in the case of high-density recordable optical data media which operate with blue laser diodes, in particular GaN or SHG laser diodes (360-460 nm) and/or for use in the case of DVD-R or CD-R discs which operate with red (635-660 nm) or infrared (760-830 nm) laser diodes, and the application of the abovementioned dyes to a polymer substrate, made from for example polycarbonates, copolycarbonates, polycycloolefines, polyolefines, by spin-coating, vapour deposition or sputtering.

The singly recordable compact disc (CD-R, 780 nm) has recently been experiencing enormous growth in quantity and is a technically established system.

Recently, the next generation of optical data stores—the DVD—was launched on the market. By using shorter-wave laser radiation (635 to 660 nm) and a higher numerical aperture NA, the storage density can be increased. In this case, the singly recordable format is the DVD-R.

Optical data storage formats which use blue laser diodes (based on GaN, JP-A-08 191 171 or Second Harmonic Generation SHG JP-A-09 050 629) (360 nm to 460 nm) having a high laser power are now being developed. Recordable optical data stores are therefore also used in this generation. The recordable storage density depends on the focusing of the laser spot in the information plane. The spot size is scaled with the laser wavelength λ/NA. NA is the numerical aperture of the lens used. In order to obtain as high a storage density as possible, the use of as short a wavelength λ as possible is desirable. At present, 390 nm are possible on the basis of semiconductor laser diodes.

The patent literature describes recordable optical data stores which are based on dyes and are just as suitable for CD-R and DVD-R systems (JP-A 11 043 481 and JP-A 10 181 206). Here, for high reflectivity and a high modulation amplitude of the read-out signal, and for sufficient sensitivity during recording, use is made of the fact that the IR wavelength 780 nm of the CD-R lies at the foot of the long-wave flank of the absorption peak of the dye, and the red wavelength 635 nm or 650 nm of the DVD-R also lies at the foot of the long-wave flank of the absorption peak of the. This concept is extended to include the region of 450 nm operating wavelength on the long-wave flank of the absorption peak.

In addition to the abovementioned optical properties, the recordable information layer comprising light-absorbing organic substances must have a morphology which is as amorphous as possible, in order to minimize the noise signal during recording and read-out. For this purpose, it is particularly preferred if, during application of the substances by spin-coating from a solution, by sputtering or by vapour deposition and/or sublimation, crystallization of the light-absorbing substances is prevented during the subsequent overcoating with metallic or dielectric layers in vacuo.

The amorphous layer of light-absorbing substances should preferably have a high heat distortion resistance, since otherwise further layers of organic or inorganic material which are applied by sputtering or vapour deposition to the light-absorbing information layer will form ill-defined interfaces through diffusion and thus adversely affect the reflectivity. In addition, light-absorbing substances having too low a heat distortion resistance at the interface with a polymeric substrate can diffuse into the latter and once again adversely affect the reflectivity.

If a light-absorbing substance has too high a vapour pressure, said substance can sublime during the abovementioned sputtering or vapour deposition of further layers in a high vacuum and hence reduce the desired layer thickness. This in turn leads to an adverse effect on the reflectivity.

Upon comprising a high NA lens as an objective lens in purpose to achieve as high areal density as possible, the thickness of transparent layer, which a readout beam transmit through when focusing on the information layer, namely the substrate or cover layer, will restrict its skew margin. Since the NA of CD and DVD objective lens are 0.45 and 0.60 respectively, their substrate thickness were chosen as 1.2 mm and 0.6 mm respectively to assure its sufficient skew margin for mass productive optical drives. The thickness of the cover layer is of significant importance for mass production since the production process will be totally different from the conventional medium, and accordingly the recording/readout performance of the medium should also be optimised for such newly designed medium. Since such thin cover layer will be easily bent and thus it is not appropriate to coat the information layer directly on the cover, the information layer and protective layer will be formed on a thick substrate before the cover layer is fixed on the substrate. CD-R and DVD-R utilize a UV resin hard cover both on purpose for the protective layer and also to cover the information layer with sufficient hardness to improve its recording properties(JP-A 2834420).

It is accordingly an object of the invention to provide suitable compounds which meet the high requirements (such as light stability, advantageous signal/noise ratio, damage-free application to the substrate material, etc.) for use in the information layer in a singly recordable optical data medium, in particular for high-density recordable optical data storage formats in a laser wavelength range of from 360 to 460 nm.

Surprisingly, it was found that light-absorbing compounds from the group consisting of dyes in combination with special parameters of the cover layer thickness accompanied with the NA, preferably phthalocyanine dyes and merocyanine dyes can fulfil the abovementioned requirement profile particularly well. Especially Phthalocyanines have an intense absorption in the wavelength range of 360-460 nm important for the laser, i.e. the B or Soret band. Merocyanines have an intense absorption in the wavelength range of 420-550 nm making them suited for the laser.

The present invention therefore relates to an optical data medium, containing a preferably transparent substrate which is optionally already coated with one or more barrier layers and on the surface of which an information layer which can be recorded on using light, optionally one or more barrier layers and a cover layer, applied by an adhesive layer, have been applied, which can be recorded on and read using focused blue light through the cover layer on the information layer, preferably laser light, particularly preferably light at 360-460 nm, in particular 380-440 nm, very particularly preferably at 395-415 nm, the information layer containing a light-absorbing compound and optionally a binder, characterized in that at least one dye is used as the light-absorbing compound wherein the cover layer on the top of the information layer including the adhesive layer do have a total thickness of 10 μm to 177 μm and the numerical aperture NA of the focusing objective lens setup is greater or equal 0.8 preferable 0.80 to 0.95.

Preferred are merocyanines as light-absorbing compound, most preferably compounds of the formula

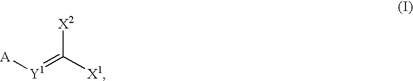

are preferred, wherein

A represents a radical of the formula

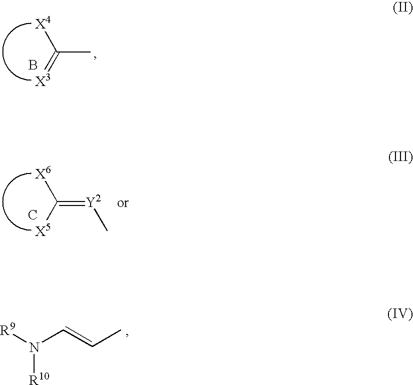

X¹ represents CN, CO—R¹, COO—R², CONHR³ or CONR³R⁴,

X² represents hydrogen, C₁- to C₆-alkyl, C₆- to C₁₀-aryl, a five- or six-membered heterocyclic radical, CN, CO—R¹, COO—R², CONHR³ or CONR³R⁴ or

CX¹X² represents a ring of the formulae

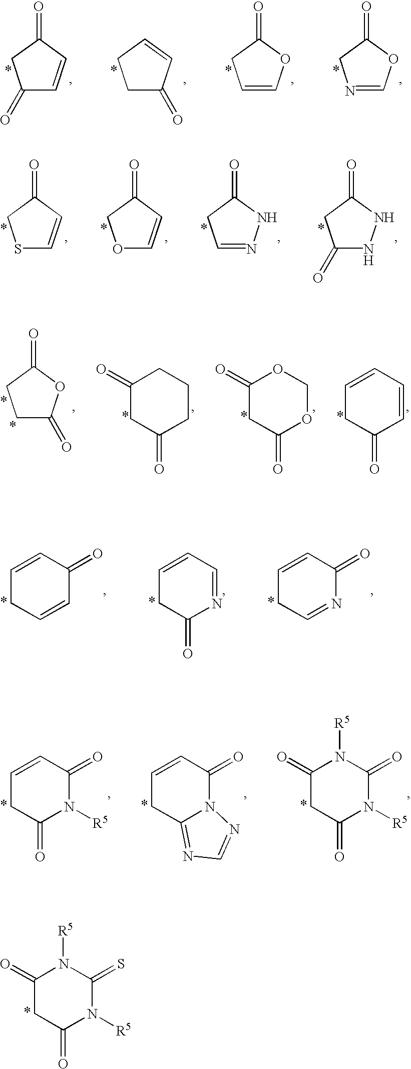

which can be benzo- or naphtha-fused and/or substituted by non-ionic or ionic radicals and wherein the asterisk (*) indicates the ring atom from which the double bond emanates,

X³ represents N or CH,

X⁴ represents O, S, N, N—R⁶ or CH, wherein X³ and X⁴ do not simultaneously represent CH,

X⁵ represents O, S or N—R⁶,

X⁶ represents O, S, N, N—R⁶, CH or CH₂,

the ring B of the formula (II)

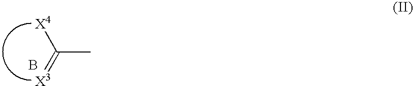

together with X⁴, X³ and the C atom bound there-between

and the ring C of the formula (V)

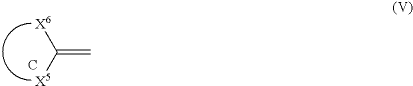

together with X⁵, X⁶ and the C atom bound there-between independently of one another represent a five- or six-membered aromatic or quasi-aromatic heterocyclic ring which can contain 1 to 4 hetero atoms and/or can be benzo- or naphtha-fused and/or substituted by non-ionic or ionic radicals,

Y¹ represents N or C—R⁷,

Y² represents N or C—R⁸,

R¹ to R⁶ independently of one another represent hydrogen, C₁ to C₆-alkyl, C₃ to C₆-alkenyl, C₅ to C₇-cycloalkyl, C₆- to C₁₀-aryl or C₇ to C₁₅-aralkyl,

R⁷ and R⁸ independently of one another represent hydrogen, cyano or C₁ to C₆-alkyl,

R⁹ and R¹⁰ independently of one another represent C₁ to C₆-alkyl, C₆ to C₁₀-aryl or C₇ to C₁₅-aralkyl or

NR⁹R¹⁰ represents a 5- or 6-membered saturated heterocyclic ring.

Oligomeric and polymeric merocyanine dyes of the formula (I) are also preferred in which at least one of the radicals R¹ to R¹⁰ or at least one of the non-ionic radicals represent a bridge. This bridge can link two or more merocyanine dyes to form oligomers or polymers. It can however also represent a bridge to a polymeric chain. In this case the merocyanine dyes are bonded in a comb-like fashion to such a chain.

Suitable bridges are for example those of the formulae —(CH₂)ₙ— or —(CH₂)ₘ—Z—(CH₂)ₚ—,

wherein

n and m independently of each other represent an integer from 1 to 20 and

Z represents —O— or —C₆H₄—.

Polymeric chains are for example polyacrylates, polymethacrylates, polyacrylamides, polymethacrylamides, polysiloxanes, poly-α-oxiranes, polyethers, polyamides, polyurethanes, polyureas, polyesters, polycarbonates, polystyrene or polymaleic acid.

Suitable non-ionic radicals are for example C₁ to C₄-alkyl, C₁ to C₄-alkoxy, halogen, cyano, nitro, C₁ to C₄-alkoxycarbonyl, C₁ to C₄-alkylthio, C₁- to C₄-alkanoylamino, benzoylamino, mono- or di-C₁ to C₄-alkylamino, pyrrolidino, piperidino, piperazino or morpholino.

Suitable ionic radicals are for example ammonium radicals or COO⁻— or SO₃⁻—radicals which can be bonded via a direct bond or via —(CH₂)ₙ—, wherein n represents an integer from 1 to 6.

Alkyl, alkoxy, aryl and heterocyclic radicals can optionally contain other radicals such as alkyl, halogen, nitro, cyano, CO—NH₂, alkoxy, trialkylsilyl, trialkylsiloxy or phenyl, the alkyl and alkoxy radicals can be straight-chained or branched, the alkyl radicals can be partially halogenated or perhalogenated, the alkyl and alkoxy radicals can be ethoxylated or propoxylated or silylated, adjacent alkyl and/or alkoxy radicals on aryl or heterocyclic radicals can together form a three- or four-membered bridge and the heterocyclic radicals can be benzo-fused and/or quaternized.

Particularly Preferably

the ring B of the formula (II) represents furan-2-yl, thiophen-2-yl, pyrrol-2-yl, benzofuran-2-yl, benzothiophen-2-yl, thiazol-5-yl, imidazol-5-yl, 1,3,4-thiadiazol-2-yl, 1,3,4-triazol-2-yl, 2- or 4-pyridyl, 2- or 4-quinolyl, wherein the individual rings can be substituted by C₁ to C₆-alkyl, C₁ to C₆-alkoxy, fluorine, chlorine, bromine, iodine, cyano, nitro, C₁ to C₆-alkoxycarbonyl, C₁- to C₆-alkylthio, C₁ to C₆-acylamino, C₆ to C₁₀-aryl, C₆ to C₁₀-aryloxy, C₆ to C₁₀-arylcarbonylamino, mono- or di-Ci to C₆-alkylamino, N—C₁ to C₆-alkyl-N—C₆ to C₁₀-arylamino, pyrrolidino, morpholino or piperidino and

the ring C of the formula (V) represents benzothiazol-2-ylidene, benzoxazol-2-ylidene, benzimidazol-2-ylidene, thiazol-2-ylidene, isothiazol-3-ylidene, isoxazol-3-ylidene, imidazol-2-ylidene, pyrazol-5-ylidene, 1,3,4-thiadiazol-2-ylidene, 1,3,4-oxadiazol-2-ylidene, 1,2,4-thiadiazol-5-ylidene, 1,3,4-triazol-2-ylidene, 3H-indol-2-ylidene, dihydropyridin-2- or -4-ylidene, or dihydroquinolin-2- or -4-ylidene, wherein the individual rings can be substituted by C₁ to C₆-alkyl, C₁ to C₆-alkoxy, fluorine, chlorine, bromine, iodine, cyano, nitro, C₁ to C₆-alkoxycarbonyl, C₁ to C₆-alkylthio, C₁ to C₆-acylamino, C₆ to C₁₀-aryl, C₆- to C₁₀-aryloxy, C₆ to C₁₀-arylcarbonylamino, mono- or di-C₁ to C₆-alkylamino, N—C₁ to C₆-alkyl-N—C₆ to C₁₀-arylamino, pyrrolidino, morpholino or piperidino.

In a particularly preferred form the merocyanines used are those of the formula (VI)

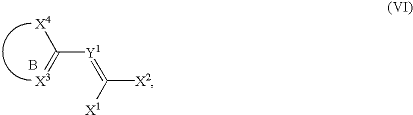

wherein

X¹ represents CN, CO—R¹ or COO—R²,

X² represents hydrogen, methyl, ethyl, phenyl, 2- or 4-pyridyl, thiazol-2yl, benzothiazol-2-yl, benzoxazol-2-yl, CN, CO—R¹ or COO—R², or

CX¹X² represents a ring of the formulae

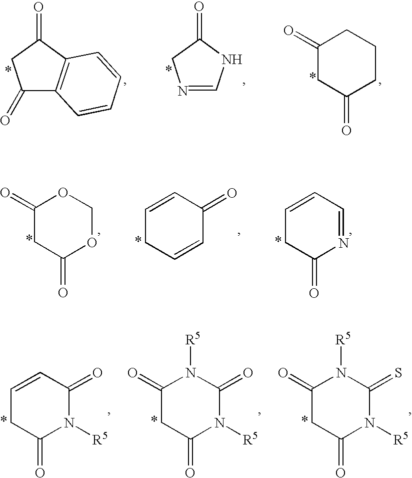

which can be substituted by up to 3 radicals from the group comprising methyl, ethyl, methoxy, ethoxy, fluorine, chlorine, bromine, cyano, nitro, methoxycarbonyl, ethoxycarbonyl, phenyl,

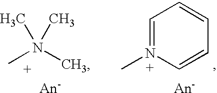

SO₃⁻M⁺ and —CH₂—SO₃⁻M⁺,

and wherein the asterisk (*) indicates the ring atom from which the double bond emanates,

An⁻ represents an anion,

M⁺ represents a cation,

X³ represents CH,

X⁴ represents O, S or N—R⁶,

the ring B of the formula (II) represents furan-2-yl, thiophen-2-yl, pyrrol-2-yl or thiazol-5-yl, wherein the above-mentioned rings can each be substituted by methyl, ethyl, propyl, butyl, methoxy, ethoxy, fluorine, chlorine, bromine, cyano, nitro, methoxycarbonyl, ethoxycarbonyl, methylthio, ethylthio, dimethylamino, diethylamino, dipropylamino, dibutylamino, N-methyl-N-phenylamino, pyrrolidino or morpholino,

Y¹ represents N or C—R⁷,

R¹, R², R⁵ and R⁶ independently of one another represent hydrogen, methyl, ethyl, propyl, butyl, pentyl, hexyl, phenyl or benzyl and

R ⁵ additionally represents —(CH₂)₃—N(CH₃)₂ or —(CH₂)₃—N⁺(CH₃)₃ An⁻ and

R⁷ represents hydrogen or cyano.

In a form also particularly preferred the merocyanines used are those of the formula (VII)

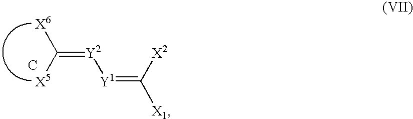

in which

X¹ represents CN, CO—R¹ or COO—R²,

X² represents hydrogen, methyl, ethyl, phenyl, 2- or 4-pyridyl, thiazol-2yl, benzothiazol-2-yl, benzoxazol-2-yl, CN, CO—R¹ or COO—R² or

CX¹X² represents a ring of the formulae

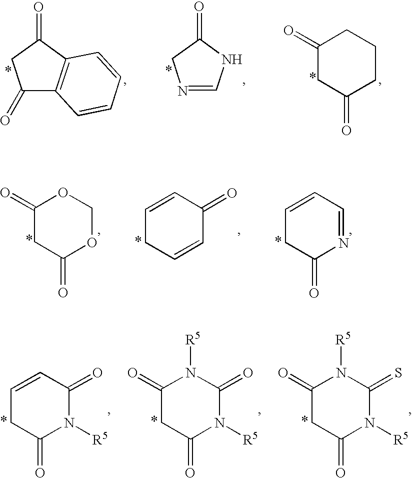

which can be substituted by up to 3 radicals from the group comprising methyl, ethyl, methoxy, ethoxy, fluorine, chlor, bromine, cyano, nitro, methoxycarbonyl, ethoxycarbonyl, phenyl,

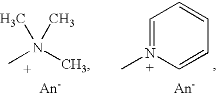

SO₃⁻M⁺ and —CH₂—SO₃⁻M⁺,

and wherein the asterisk (*) indicates the ring atom from which the double bond emanates,

An⁻ represents an anion,

M⁺ represents a cation,

X⁵ represents N—R⁶,

X⁶ represents S, N—R⁶ or CH₂,

the ring C of the formula (IV) represents benzothiazol-2-ylidene, benzimidazol-2-ylidene, thiazol-2-ylidene, 1,3,4-thiadiazol-2-ylidene, 1,3,4-triazol-2-ylidene, dihydropyridin-4-ylidene, dihydroquinolin-4-ylidene or 3H-indol-2-ylidene, wherein the above-mentioned rings can each be substituted by methyl, ethyl, propyl, butyl, methoxy, ethoxy, fluorine, chlorine, bromine, cyano, nitro, methoxycarbonyl, ethoxycarbonyl, methylthio, ethylthio, dimethylamino, diethylamino, dipropylamino, dibutylamino, N-methyl-N-phenylamino, pyrrolidino or morpholino,

Y²—Y¹ represents N—N or (C—R⁸)—(C—R⁷),

R¹, R², R⁵ and R⁶ independently of one another represent hydrogen, methyl, ethyl, propyl, butyl, pentyl, hexyl, phenyl or benzyl and

R⁵ additionally represents —(CH₂)₃—N(CH₃)₂ or —(CH₂)₃—N⁺(CH₃)₃ An⁻ and

R⁷ and R⁸ represent hydrogen.

In a form also particularly preferred the merocyanines used are those of the formula (VIII)

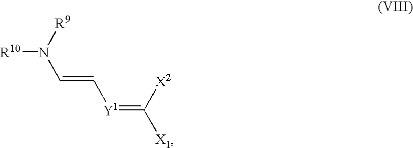

wherein

X¹ represents CN, CO—R¹ or COO—R²,

X² represents hydrogen, methyl, ethyl, phenyl, 2- or 4-pyridyl, thiazol-2yl, benzo-thiazol-2-yl, benzoxazol-2-yl, CN, CO—R¹ or COO—R², or

CX¹X² represents a ring of the formulae

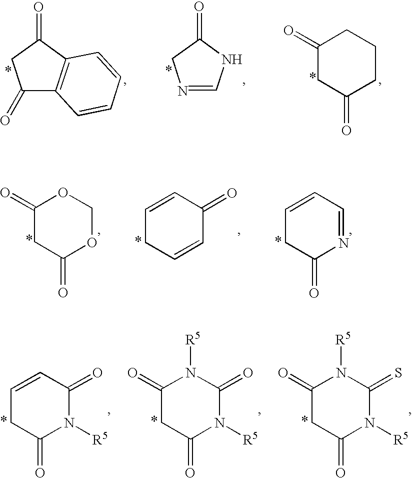

which can be substituted by up to 3 radicals from the group comprising methyl, ethyl, methoxy, ethoxy, fluorine, chlorine, bromine, cyano, nitro, methoxycarbonyl, ethoxycarbonyl, phenyl,

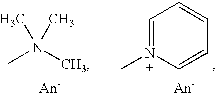

SO₃⁻M⁺ and —CH₂—SO₃⁻M⁺,

and wherein the asterisk (*) indicates the ring atom from which the double bond emanates,

An⁻ represents an anion,

M⁺ represents a cation,

NR⁹R¹⁰ represents dimethylamino, diethylamino, dipropylamino, dibutylamino, N-methyl-N-phenylamino, pyrrolidino or morpholino,

Y¹ represents N or C—R⁷,

R¹, R² and R⁵ independently of one another represent hydrogen, methyl, ethyl, propyl, butyl, pentyl, hexyl, phenyl or benzyl and

R⁵ additionally represents —(CH₂)₃—N(CH₃)₂ or —(CH₂)₃—N⁺(CH₃)₃ An⁻.

Suitable anions An⁻ are all monovalent anions or one equivalent of a polyvalent anion. Preferably the anions are colourless. Suitable anions are for example chloride, bromide, iodide, tetrafluoroborate, perchlorate, hexafluorosilicate, hexafluoro-phosphate, methosulphate, ethosulphate, C₁ to C₁₀-alkanesulphonate, C₁ to C₁₀-perfluoroalkanesulphonate, C₁ to C₁₀-alkanoate optionally substituted by chlorine, hydroxyl or C₁ to C₄-alkoxy, benzene sulphonate, naphthalene sulphonate or biphenyl sulphonate, which are optionally substituted by nitro, cyano, hydroxyl, C₁ to C₂₅-alkyl, perfluoro-C₁ to C₄-alkyl, C₁ to C₄-alkoxycarbonyl or chlorine, benzene disulphonate, naphthalene disulphonate or biphenyl disulphonate, which are optionally substituted by nitro, cyano, hydroxyl, C₁ to C₄-alkyl, C₁ to C₄-alkoxy, C₁- to C₄-alkoxycarbonyl or chlorine, benzoate which is optionally substituted by nitro, cyano, C₁ to C₄-alkyl, C₁ to C₄-alkoxy, C₁ to C₄-alkoxycarbonyl, benzoyl, chloro-benzoyl or toluoyl, the anion of naphthalenedicarboxylic acid, diphenyl ether disulphonate, tetraphenyl borate, cyanotriphenyl borate, tetra-Ci to C₂₀-alkoxyborate, tetraphenoxyborate, 7,8- or 7,9-dicarba-nido-undecaborate(1) or (2), which are optionally substituted on the B and/or C atoms by one or two C₁ to C₁₂-alkyl or phenyl groups, dodecahydro-dicarbadodecaborate(2) or B—C₁ to C₁₂-alkyl-C-phenyl-dodecahydro-dicarbadodeca-borate(1).

Bromide, iodide, tetrafluoroborate, perchlorate, methane sulphonate, benzene sulphonate, toluene sulphonate, dodecylbenzene sulphonate and tetradecane sulphonate are preferred.

Suitable M⁺ cations are all monovalent cations or one equivalent of a polyvalent cation. The cations are preferably colourless. Suitable cations are for example lithium, sodium, potassium, tetramethyl ammonium, tetraethyl ammonium, tetrabutyl ammonium, trimethylbenzyl ammonium, trimethylcapryl ammonium or Fe(C₅H₅)₂⁺(in which C₅H₅=cyclopentadienyl).

Tetramethyl ammonium, tetraethyl ammonium and tetrabutyl ammonium are preferred.

For a, preferably singly recordable, optical data carrier according to the invention which is written and read by light from a blue laser such merocyanine dyes are preferred whose absorption maximum λₘₐₓ₂ is in the range from 420 bis 550 nm, wherein the wavelength λ_{½} at which the extinction on the shortwave slope of the absorption maximum of the wavelength λₘₐₓ₂ is half the extinction value at λₘₐₓ₂ and the wavelength λ_{1/10} at which the extinction on the shortwave slope of the absorption maximum of the wavelength λₘₐₓ₂ is a tenth of the extinction value at λₘₐₓ₂, are preferably in each case no further than 50 nm away from each other. Preferably such a merocyanine dye does not display a shorter-wave maximum λₘₐₓ₁ at a wavelength below 350 nm, particularly preferably below 320 nm, and very particularly preferably below 290 nm.

Preferred merocyanine dyes are those with an absorption maximum λₘₐₓ₂ of 410 to 530 nm.

Particularly preferred merocyanine dyes are those with an absorption maximum λₘₐₓ₂ of 420 to 510 nm.

Very particularly preferred merocyanine dyes are those with an absorption maximum λₘₐₓ₂ of 430 to 500 nm.

Preferably λ_{½} and λ_{1/10}, as defined above, are no further than 40 nm, particularly preferably no further than 30 nm, and very particularly preferably no further than 20 nm away from each other in the merocyanine dyes.

The merocyanine dyes have a molar extinction coefficient ε of >40000 l/mol cm, preferably >60000 l/mol cm, particularly preferably >80000 l/mol cm, and very particularly preferably >100000 l/mol cm at the absorption maximum λₘₐₓ₂.

The absorption spectra are measured for example in solution.

Suitable merocyanines having the required spectral properties are in particular those in which the change in dipole moment Δμ=|μ_{g}-μ_{ag}|, i.e. the positive difference between the dipole moments in the ground state and in the first excited state, is as small as possible, preferably <5 D, and particularly preferably <2 D. One method of determining such a change in dipole moment Δμ is described for example in F. Würthner et al., Angew. Chem. 1997, 109, 2933 and in the literature cited therein. Low solvatochromism (dioxane/DMF) is also a suitable criterion for selection. Merocyanines are preferred whose solvatochromism Δλ=|λ_{DMF}-λ_{dioxane}|, i.e. the positive difference between the absorption wavelengths in the solvents dimethylformamide and dioxane is <20 nm, particularly preferably <10 nm and very particularly preferably <5 nm.

Merocyanines which are very particularly preferred according to the invention are those of the formula

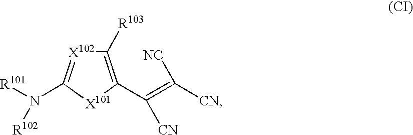

in which

X¹⁰¹ represents O or S,

X¹⁰² represents N or CR¹⁰⁴,

R¹⁰¹ and R¹⁰² independently of one another represent methyl, ethyl, propyl, butyl, pentyl, hexyl, cyclohexyl, benzyl or phenyl and R¹⁰¹ additionally represents hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰² and

R¹⁰⁴ represents hydrogen, methyl, ethyl, phenyl, chlorine, cyano, formyl or a radical of the formula

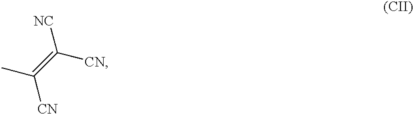

wherein the alkyl radicals such as propyl, butyl, etc. can be branched.

The attachment of a bridge for oligomeric or polymeric structures takes place via R¹⁰¹.

Merocyanines which are also very particularly preferred according to the invention are those of the formula

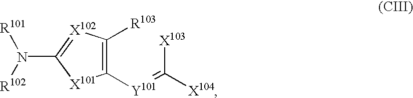

in which

X¹⁰¹ represents O or S,

X¹⁰² represents N or CR¹⁰⁴,

R¹⁰¹ and R¹⁰² independently of one another represent methyl, ethyl, propyl, butyl, pentyl, hexyl, cyclohexyl, benzyl or phenyl and R¹⁰¹ additionally represents hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

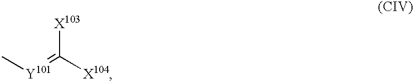

Y¹⁰¹ represents N or CH,

CX¹⁰³X¹⁰⁴ represents a ring of the formulae

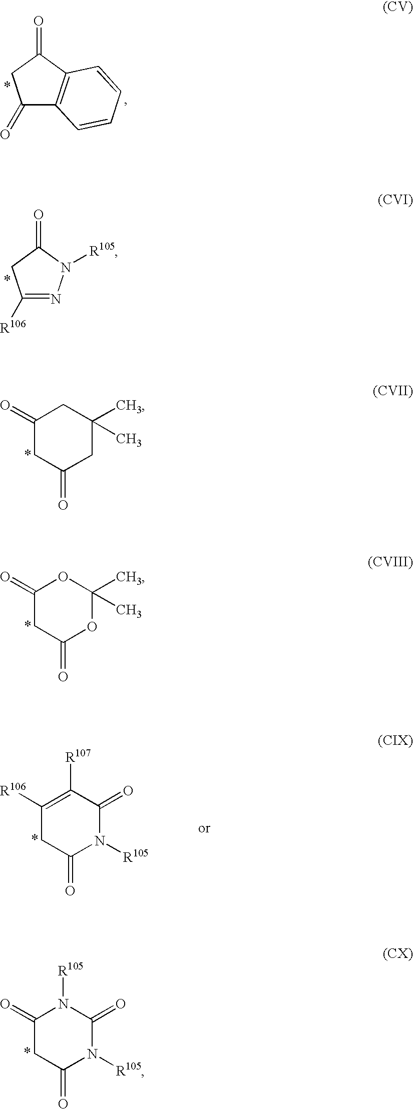

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

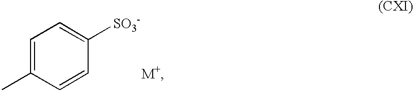

wherein in the case of the formula (CX) the two radicals R¹⁰⁵ can be different,

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃³¹ M⁺ or a radical of the formulae

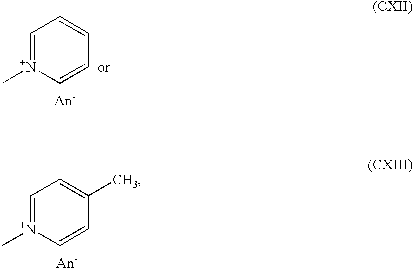

M⁺ represents a cation and

An⁻ represents an anion,

wherein the alkyl radicals such as propyl, butyl, etc. can be branched.

The attachment of a bridge for oligomeric or polymeric structures takes place via R¹⁰¹ or R¹⁰⁵.

Merocyanines which are also very particularly preferred according to the invention are those of the formula

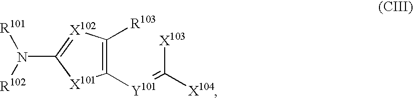

in which

X¹⁰¹ represents O or S,

X¹⁰² represents N or CR¹⁰⁴,

R¹⁰¹ and R¹⁰² independently of one another represent methyl, ethyl, propyl, butyl, pentyl, hexyl, cyclohexyl, benzyl or phenyl and R¹⁰¹ additionally represents hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

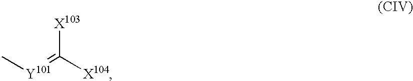

Y¹⁰¹ represents N or CH,

X¹⁰³ represents cyano, acetyl, methoxycarbonyl or ethoxycarbonyl and

X¹⁰⁴ represents 2-, 3- or 4-pyridyl, thiazol-2-yl, benzothiazol-2-yl, oxazol-2-yl, benzoxazol-2-yl, benzimidazol-2-yl, N-methyl- or N-ethyl-benzimidazol-2-yl,

wherein the alkyl radicals such as propyl, butyl, etc. can be branched.

The attachment of a bridge for oligomeric or polymeric structures takes place via R¹⁰¹ or X¹⁰³, if the latter represents an ester grouping.

Preferably, in the merocyanines of the formulae (CI) and (CIII)

R¹⁰³ represents hydrogen, methyl, i-propyl, tert.-butyl or phenyl and

R¹⁰⁴ represents hydrogen or cyano.

Merocyanines which are also very particularly preferred according to the invention are those of the formula

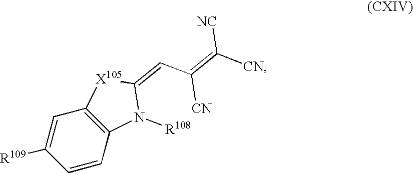

in which

X¹⁰⁵ represents S or CR¹¹⁰R¹¹¹,

R¹⁰⁸ represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, tri-fluoromethyl, trifluoromethoxy, methoxycarbonyl or ethoxycarbonyl,

R¹¹⁰ and R¹¹¹ independently of one another represent methyl or ethyl or CR¹¹⁰R¹¹¹ represents a bivalent radical of the formula

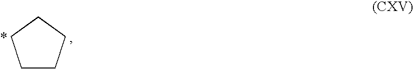

wherein two bonds emanate from the atom with an asterisk (*),

wherein the alkyl radicals such as propyl, butyl, etc. can be branched.

The attachment of a bridge for oligomeric or polymeric structures takes place via R¹⁰⁸.

Merocyanines which are also very particularly preferred according to the invention are those of the formula

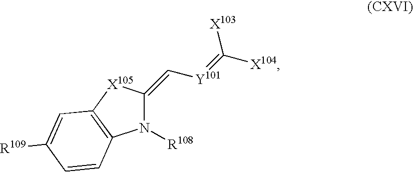

in which

X¹⁰⁵ represents S or CR¹¹⁰R¹¹¹,

R¹⁰⁸ represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, tri-fluoromethyl, trifluoromethoxy, methoxycarbonyl or ethoxycarbonyl,

R¹¹⁰ and R¹¹¹ independently of one another represent methyl or ethyl or

CR¹¹⁰R¹¹¹ represents a bivalent radical of the formula

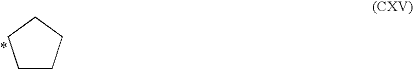

wherein two bonds emanate from the atom with an asterisk (*),

Y¹⁰¹ represents N or CH,

CX¹⁰³X¹⁰⁴ represents a ring of the formulae

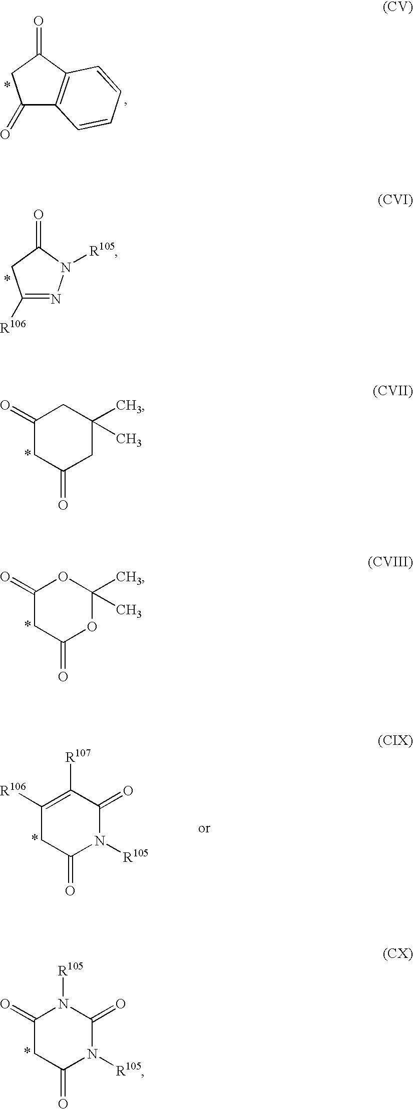

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

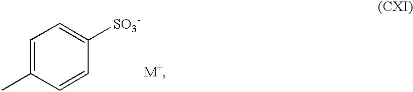

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃⁻ M⁺ or a radical of the formulae

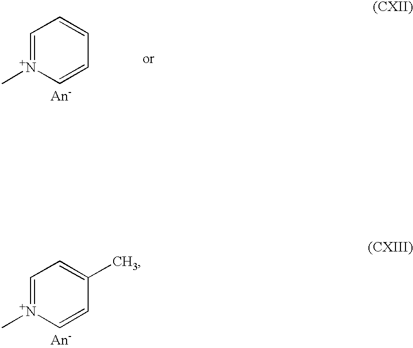

M⁺ represents a cation and

An⁻ represents an anion,

wherein the alkyl radicals such as propyl, butyl, etc. can be branched.

The attachment of a bridge for oligomeric or polymeric structures takes place via R¹⁰⁸ or R¹⁰⁵.

Merocyanines which are also very particularly preferred according to the invention are those of the formula

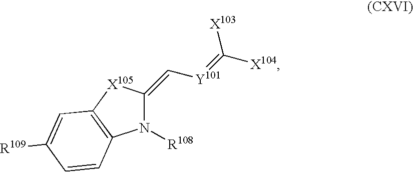

in which

X¹⁰⁵ represents S or CR¹¹⁰R¹¹¹,

R¹⁰⁸ represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, tri-fluoromethyl, trifluoromethoxy, methoxycarbonyl or ethoxycarbonyl,

R¹¹⁰ and R¹¹¹ independently of one another represent methyl or ethyl or

CR¹¹⁰R¹¹¹ represents a bivalent radical of the formula

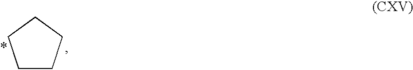

wherein two bonds emanate from the atom with an asterisk (*),

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methyl- or N-ethyl-benzimidazol-2-yl, preferably 2-pyridyl,

wherein the alkyl radicals such as propyl, butyl, etc. can be branched.

The attachment of a bridge for oligomeric or polymeric structures takes place via R¹⁰⁸ or X¹⁰³, if the latter represents an ester grouping.

Merocyanines which are also very particularly preferred according to the invention are those of the formula

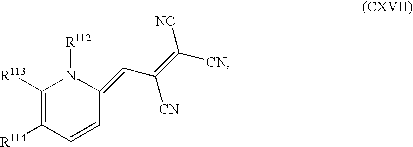

wherein

R¹¹² represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or together represent a —CH═CH—CH═CH— bridge,

wherein the alkyl radicals such as propyl, butyl etc. can be branched.

The attachment of a bridge for oligomeric or polymeric structures takes place via R¹¹².

Merocyanines which are also very particularly preferred according to the invention are those of the formula

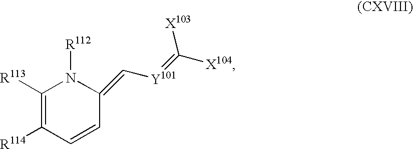

in which

R¹¹² represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or together represent a —CH═CH—CH═CH— bridge,

Y¹⁰¹ represents N or CH,

CX¹⁰³X¹⁰⁴ represents a ring of the formulae

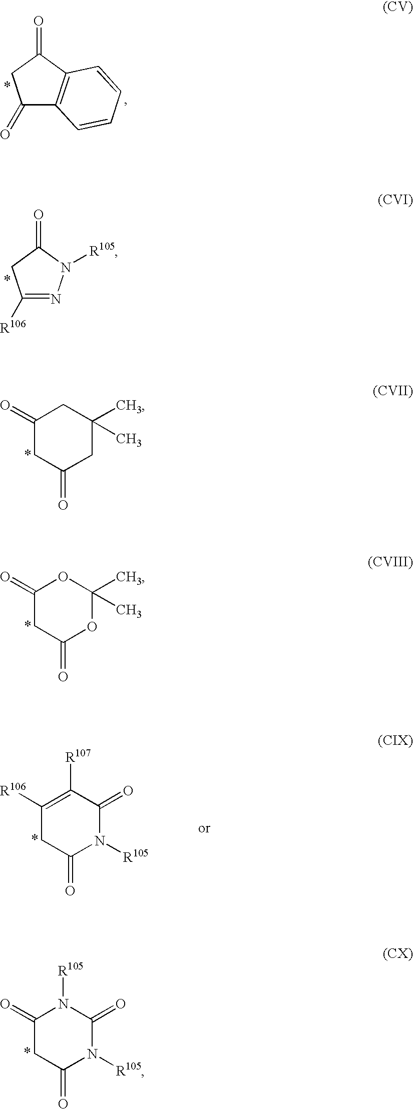

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

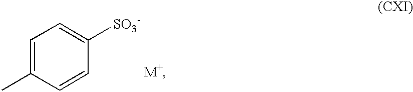

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃⁻ M⁺ or a radical of the formulae

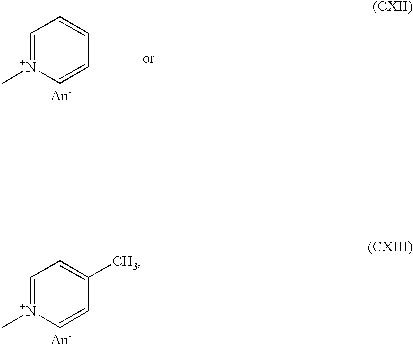

M⁺ represents a cation and

An⁻ represents an anion,

wherein the alkyl radicals such as propyl, butyl, etc. can be branched.

The attachment of a bridge for oligomeric or polymeric structures takes place via R¹¹² or R¹⁰⁵.

Merocyanines which are also very particularly preferred according to the invention are those of the formula

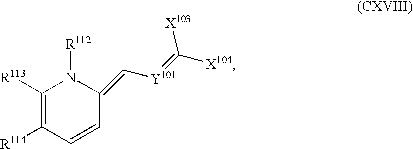

in which

R¹¹² represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or jointly represent a —CH═CH—CH═CH— bridge,

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methyl- or N-ethyl-benzimidazol-2-yl,

wherein the alkyl radicals such as propyl, butyl, etc. can be branched.

The attachment of a bridge for oligomeric or polymeric structures takes place via R¹¹² or X¹⁰³, if the latter represents an ester grouping.

Merocyanines which are also very particularly preferred according to the invention are those of the formula

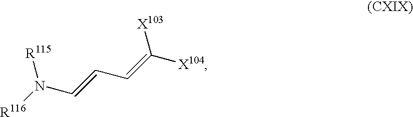

in which

R¹¹⁵ and R¹¹⁶ independently of one another represent methyl, ethyl, propyl, butyl, pentyl, hexyl, heptyl, octyl, phenyl, benzyl or phenethyl or

NR¹¹⁵R¹¹⁶ represents pyrrolidino, piperidino or morpholino,

CX¹⁰³X¹⁰⁴ represent a ring of the formulae

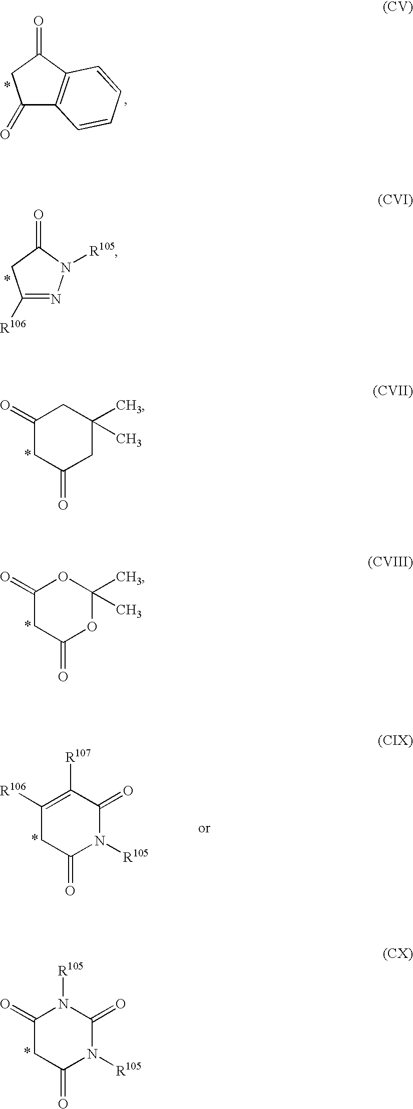

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or a radical of the formula

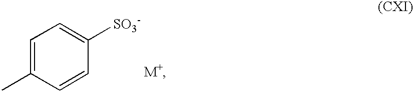

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃⁻ M⁺ or a radical of the formulae

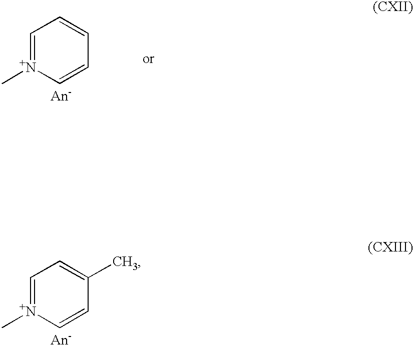

M⁺ represents a cation and

An⁻ represents an anion,

wherein the alkyl radicals such as propyl, butyl, etc. can be branched.

The attachment of a bridge for oligomeric or polymeric structures takes place via R¹¹⁵ or R¹⁰⁵.

Merocyanines which are also very particularly preferred according to the invention are those of the formula

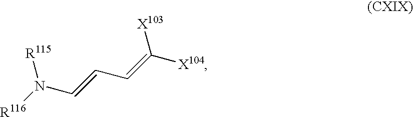

in which

R¹¹⁵ and R¹¹⁶ independently of one another represent methyl, ethyl, propyl, butyl, pentyl, hexyl, heptyl, octyl, phenyl, benzyl or phenethyl or

NR¹¹⁵R¹¹⁶ represents pyrrolidino, piperidino or morpholino,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methyl- or N-ethyl-benzimidazol-2-yl, preferably 2-pyridyl,

wherein the alkyl radicals such as propyl, butyl etc. can be branched.

The attachment of a bridge for oligomeric or polymeric structures takes place via R¹¹⁵ or X¹⁰³, if the latter represents an ester grouping.

In the formulae (CIII), (CXVI) and (CXVIII)

Y¹⁰¹ preferably represents CH and

in the formulae (CIII), (CXVI), (CXVIII) and (CXIX)

CX¹⁰³X¹⁰⁴ preferably represents a ring of the formulae (CV), (CVII) and (CIX) or a radical of the formulae

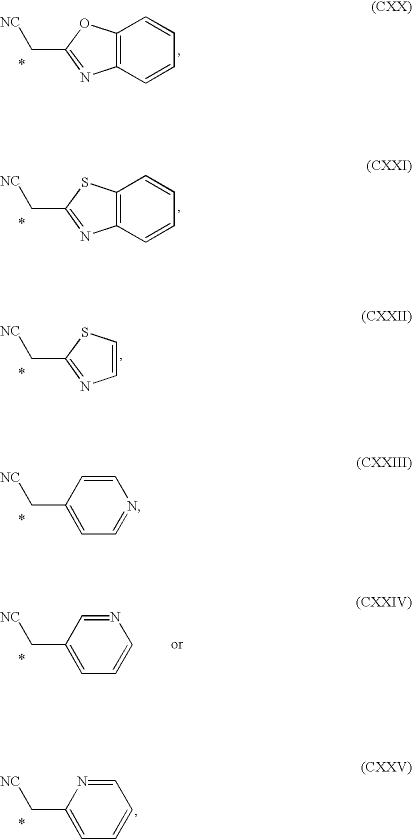

wherein the double bond emanates from the C atom with an asterisk (*).

—(CH₂)₂—, —(CH₂)₃—, —(CH₂)₄—, —(CH₂)₂—O—(CH₂) ₂— and —CH₂—C₆H₄—CH₂— are preferred bridges.

Polyacrylate and polymethacrylate and copolymers thereof with acrylamides are preferred polymer chains. The abovementioned radicals R¹⁰¹, R¹⁰⁵, R¹⁰⁸, R¹¹² and R¹¹⁵ then for example represent a monomer unit of the formula

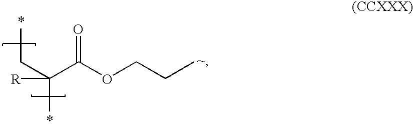

in which

R represents hydrogen or methyl and a single bond to the N atom of the merocyanine dye emanates from the atom marked with a tilde (˜) and the atoms with an asterisk (*) represent the continuation of the chain.

Some of the merocyanines of the formula (I) are known, for example from F. Wüirthner, Synthesis 1999, 2103; F. Wüirthner, R. Sens, K.-H. Etzbach, G. Seybold, Angew. Chem. 1999, 111, 1753; DE-OS 43 44 116; DE-OS 44 40 066; WO 98/23688: JP 52 99 379; JP 53 14 734.

Also preferred are phthalocyanines as light-absorbing compounds.

In a preferred embodiment, the phthalocyanine used is a compound of the formula (1)

MPc[R³]_{w}[R⁴]ₓ[R⁵]_{y}[R⁶]_{z} (1),

in which

Pc represents a phthalocyanine or a naphthocyanine, where in both cases the aromatic rings also may be heterocycles, for example tetrapyridinopor-phyrazines,

M represents two independent H atoms, represent a divalent metal atom or represents a trivalent axially monosubstituted metal atom of the formula (1a)

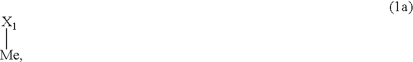

or represents a tetravalent axially disubstituted metal atom of the formula (1b)

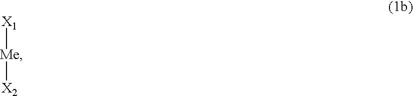

or represents a trivalent axially monosubstituted and axially monocoordinated metal atom of the formula (1c)

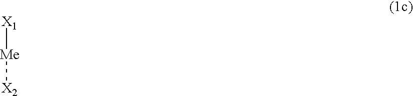

where, in the case of a charged ligand X₂ or X₁, the charge being compensated by an opposite ion, for example an anion An⊖ or cation Kat⊕,

the radicals R³ to R⁶ corresponding to substituents of the phthalocyanine ring, in which

X¹ and X², independently of one another, represent halogen as F, Cl, Br, I, hydroxyl, oxygen, cyano, thiocyanato, cyanato, alkenyl, alkinyl, arylthio, dialkylamino, alkyl, alkoxy, acyloxy, alkylthio, aryl, aryloxy, —O—SO₂R⁸, —O—PR¹⁰R¹¹, —O—P(O)R¹²R¹³, —O—SiR¹⁴R¹⁵R¹⁶, NH₂, alkylamino and the radical of a hetero-cyclic amine,

R³, R⁴, R⁵ and R⁶, independently of one another, represent halogen as F, Cl, Br, I, cyano, nitro, alkyl, aryl, alkylamino, dialkylamino, alkoxy, alkylthio, aryloxy, arylthio, SO₃H, SO₂NR¹R², CO₂R⁹, CONR¹R², NH—COR⁷ or a radical of the formula —(B)ₘ—D, in which

B denotes a bridge member from the group consisting of a direct bond, CH₂, CO, CH(alkyl), C(alkyl)₂, NH, S, O or —CH═CH—, (B)ₘ denoting a chemically reasonable sequence of bridge members B where m is from 1 to 10, preferably m is 1, 2, 3 or 4,

D represents the monovalent radical of a redox system of the formula

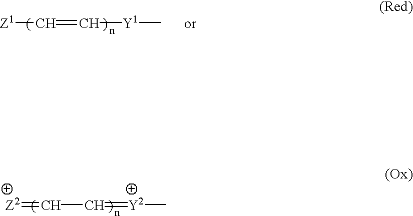

or represents a metallocenyl radical or metallocenylcarbonyl radical, titanium, manganese, iron, ruthenium or osmium being suitable as the metal centre,

Z¹ and Z², independently of one another, represent NR′R″, OR″ or SR″,

Y¹ represents NR′, O or S, Y² represents NR′,

n represents 1 to 10 and

R′ and R″, independently of one another, represent hydrogen, alkyl, cycloalkyl, aryl or hetaryl, or form. a direct bond or bridge to one of the C atoms of the

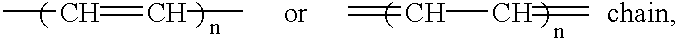

w, x, y and z, independently of one another, represent 0 to 4 and w+x+y+z≦16,

R¹and R², independently of one another, represent hydrogen, alkyl, hydroxyalkyl, or aryl, or R¹ and R², together with the N atom to which they are bonded, form a heterocyclic 5-, 6- or 7-membered ring, optionally with participation of further hetero atoms, in particular from the group consisting of O, N and S, NR¹R² representing in particular pyrrolidino, piperidino or morpholino,

R⁷ to R¹⁶, independently of one another, represent alkyl, aryl, hetaryl or hydrogen, in particular represent alkyl, aryl or hetaryl,

An⁻ represents an anion, in particular represents halide, C₁- to C₂₀-alkylCOO⁻, formate, oxalate, lactate, glycolate, citrate, CH₃OSO₃⁻, NH₂SO₃⁻, CH₃SO₃⁻, ½ SO₄²⁻ or ⅓ PO₄³⁻.

Where M represents a radical of the formula (1c), in particular with Co(III) as the metal atom, preferred heterocyclic amine ligands or substituents in the meaning of X¹ and X² are morpholine, piperidine, piperazine, pyridine, 2,2-bipyridine, 4,4-bipyridine, pyridazine, pyrimidine, pyrazine, imidazole, benzimidazole, isoxazole, benzisoxazole, oxazole, benzoxazole, thiazole, benzothiazole, quinoline, pyrrole, indole and 3,3-dimethylindole, each of which is coordinated with or substituted by the metal atom at the nitrogen atom.

The alkyl, alkoxy, aryl and heterocyclic radicals can optionally carry further radicals, such as alkyl, halogen, hydroxyl, hydroxyalkyl, amino, alkylamino, dialkylamino, nitro, cyano, CO—NH₂, alkoxy, alkoxycarbonyl, morpholino, piperidino, pyrrolidino, pyrrolidono, trialkylsilyl, trialkylsiloxy or phenyl. The alkyl and alkoxy radicals may be saturated, unsaturated, straight-chain or branched, the alkyl radical may be partly halogenated or perhalogenated and the alkyl and alkoxy radical may be ethoxylated, propoxylated or silylated. Neighbouring alkyl and/or alkoxy radicals on aryl or heterocyclic radicals may together form a three- or four-membered bridge.

Preferred compounds of the formula (1) are those in which the following applies for the radical R¹to R¹⁶, R′ and R″ and for the ligands or substituents X¹ and X²:

substituents with the designation “alkyl” preferably denote C₁-C₁₆-alkyl, in particular C₁-C₆-alkyl, which are optionally substituted by halogen, such as chlorine, bromine or fluorine, hydroxyl, cyano and/or C₁-C₆-alkoxy;

substituents with the designation “alkoxy” preferably denote C₁-C₁₆-alkoxy, in particular C₁-C₆-alkoxy which are optionally substituted by halogen, such as chlorine, bromine or fluorine, hydroxyl, cyano and/or C₁-C₆-alkyl;

substituents with the designation “cycloalkyl” preferably denote C₄-C₈-cycloalkyl, in particular C₅- to C₆-cycloalkyl, which are optionally substituted by halogen, such as chlorine, bromine or fluorine, hydroxyl, cyano and/or C₁-C₆-alkyl.

substituents with the designation “alkenyl” preferably denote C₆-C₈-alkenyl which are optionally substituted by halogen, such as chlorine, bromine or fluorine, hydroxyl, cyano and/or C₁-C₆-alkyl, alkenyl denoting in particular allyl,

substituents with the meaning “hetaryl” preferably represent heterocyclic radicals having 5- to 7-membered rings which preferably contain hetero atoms from the group consisting of N, S and/or O and are optionally fused with aromatic rings or optionally carry further substituents, for example halogen, hydroxyl, cyano and/or alkyl, the following being particularly preferred: pyridyl, furyl, thienyl, oxazolyl, thiazolyl, imidazolyl, quinolyl, benzoxazolyl, benzothiazolyl and benzimidazolyl, the substituents with the designation “aryl” are preferably C₆-C₁₀-aryl, in particular phenyl or naphthyl, which are optionally substituted by halogen, such as F or Cl, hydroxyl, C₁-C₆-alkyl, C₁-C₆-alkoxy, NO₂ and/or CN.

R³, R⁴, R⁵ and R⁶, independently of one another preferably represent chlorine, fluorine, bromine, iodine, cyano, methyl, ethyl, propyl, isopropyl, butyl, isobutyl, tert-butyl, pentyl, tert-amyl, hydroxyethyl, 3-dimethylaminopropyl, 3-diethylaminopropyl, phenyl, p-tert-butylphenyl, p-methoxyphenyl, iso-propylphenyl, trifluoromethylphenyl, naphthyl, methylamino, ethylamino, propylamino, isopropylamino, butylamino, isobutylamino, tert-butylamino, pentylamino, tert-amylamino, benzylamino, methylphenylhexylamino, hydroxyethylamino, aminopropylamino, aminoethylamino, 3-dimethylamino-propylamino, 3-diethylaminopropylamino, diethylaminoethylamino, dibutyl-aminopropylamino, morpholinopropylamino, piperidinopropylamino, pyrrolidinopropylamino, pyrrolidonopropylamino, 3-(methylhydroxyethyl-amino)propylamino, methoxyethylamino, ethoxyethylamino, methoxypropyl-amino, ethoxypropylamino, methoxyethoxypropylamino, 3-(2-ethylhexyl-oxy)propylamino, isopropyloxypropylamino, dimethylamino, diethylamino, diethanolamino, dipropylamino, diisopropylamino, dibutylamino, diiso-butylamino, di-tert-butylamino, dipentylamino, di-tert-amylamino, bis(2-ethylhexyl)amino, bis(aminopropyl)amino, bis(aminoethyl)amino, bis(3-dimethylaminopropyl)amino, bis(3-diethylaminopropyl)amino, bis(diethyl-aminoethyl)amino, bis(dibutylaminopropyl)amino, di(morpholinopropyl)-amino, di(piperidinopropyl)amino, di(pyrrolidinopropyl)amino, di(pyrroli-donopropyl)amino, bis(3-(methyl-hydroxyethylamino)propyl)amino, dimethoxyethylamino, diethoxyethylamino, dimethoxypropylamino, diethoxypropyl-amino, di(methoxyethoxyethyl)amino, di(methoxyethoxypropyl)amino, bis(3-(2-ethylhexyloxy)propyl)amino, di(isopropyloxyisopropyl)amino, methoxy,ethoxy, propyloxy, isopropyloxy, butyloxy, isobutyloxy, tert-butyloxy, pentyloxy, tert-amyloxy, methoxyethoxy, ethoxyethoxy, methoxypropyloxy, ethoxypropyloxy, methoxyethoxypropyloxy, 3-(2-ethylhexyloxy)propyloxy, methylthio, ethylthio, propylthio, isopropylthio, butylthio, isobutylthio, tert-butylthio, pentylthio, tert-amylthio, phenyl, methoxyphenyl, trifluoro-methylphenyl, naphthyl, CO₂R⁷, CONR¹R², NH—COR⁷, SO₃H, SO₂NR¹R² or preferably represent a radical of the formula

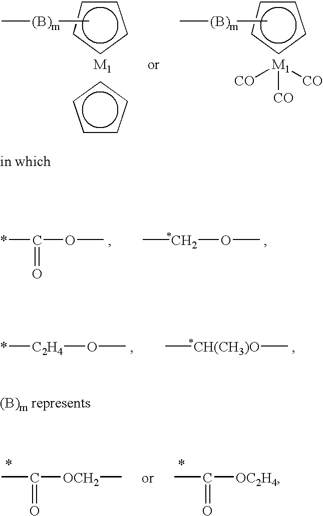

where the asterisk (*) indicates the link with the 5-membered ring,

M₁ represents an Mn or Fe cation,

w, x, y and z, independently of one another, represent 0 to 4 and w+x+y+z≦12,

NR¹R² preferably represent amino, methylamino, ethylamino, propylamino, isopropylamino, butylamino, isobutylamino, tert. butylamino, pentylamino, tert. amylamino, benzylamino, methylphenylhexylamino, 2-ethyl-1-hexyl-amino, hydroxyethylamino, aminopropylamino, aminoethylamino, 3-di-methylaminopropylamino, 3-diethylaminopropylamino, morpholinopropyl-amino, piperidinopropylamino, pyrrolidinopropylamino, pyrrolidono-propylamino, 3-(methyl-hydroxyethylamino)propylamino, methoxyethyl-amino, ethoxyethylamino, methoxypropylamino, ethoxypropylamino, methoxyethoxypropylamino, 3-(2-ethylhexyloxy)propylamino, isopropyloxy-isopropylamino, dimethylamino, diethylamino, dipropylamino, diisopropyl-amino, dibutylamino, diisobutylamino, di-tert-butylamino, dipentylamino, di-tert-amylamino, bis(2-ethylhexyl)amino, dihydroxyethylamino, bis(amino-propyl)amino, bis(aminoethyl)amino, bis(3-dimethylaminopropyl)amino, bis-(3-diethylaminopropyl)amino, di(morpholinopropyl)amino, di(piperidinopropyl)amino, di(pyrrolidinopropyl)amino, di(pyrrolidonopropyl)amino, bis(3-(methyl-hydroxyethylamino)propyl)amino, dimethoxyethylamino, diethoxy-ethylamino, dimethoxypropylamino, diethoxypropylamino, di(methoxy-ethoxypropyl)amino, bis(3-(2-ethylhexyloxy)propyl)amino, di(isopropyloxy-isopropyl)amino, anilino, p-toluidino, p-tert-butylanilino, p-anisidino, isopropylanilino or naphtylamino or NR¹R² preferably represent pyrrolidino, piperidino, piperazino or morpholino,

R⁷ and R¹⁶, independently of one another preferably represent hydrogen, methyl, ethyl, propyl, isopropyl, butyl, isobutyl, tert-butyl, pentyl, tert-amyl, phenyl, p-tert-butylphenyl, p-methoxyphenyl, isopropylphenyl, p-trifluoromethyl-phenyl, cyanophenyl, naphthyl, 4-pyridyl, 2-pyridyl, 2-quinolinyl, 2-pyrrolyl or 2-indolyl,

it being possible for the alkyl, alkoxy, aryl and heterocyclic radicals optionally to carry further radicals, such as alkyl, halogen, hydroxyl, hydroxyalkyl, amino, alkyl-amino, dialkylamino, nitro, cyano, CO—NH₂, alkoxy, alkoxycarbonyl, morpholino, piperidino, pyrrolidino, pyrrolidono, trialkylsilyl, trialkylsilyloxy or phenyl, for the alkyl and/or alkoxy radicals to be saturated, unsaturated, straight-chain or branched, for the alkyl radicals to be partly halogenated or perhalogenated, for the alkyl and/or alkoxy radicals to be ethoxylated, propoxylated or silylated, and for neighbouring alkyl and/or alkoxy radicals on aryl or heterocyclic radicals together to form a three- or four-membered bridge.

In the context of this application, redox systems are understood as meaning in particular the redox systems described in Angew. Chem. 1978, page 927, and in Topics of Current Chemistry, Vol. 92, page 1 (1980).

p-Phenylenediamines, phenothiazines, dihydrophenazines, bipyridinium salts (viologens) and quinodimethanes are preferred.

In a preferred embodiment, phthalocyanines of the formula (1),

in which

M represents two independent H atoms or represents a divalent metal atom Me from the group consisting of Cu, Ni, Zn, Pd, Pt, Fe, Mn, Mg, Co, Ru, Ti, Be, Ca, Ba, Cd, Hg, Pb and Sn

or

M represents a trivalent axially monosubstituted metal atom of the formula (1a), in which the metal Me is selected from the group consisting of Al, Ga, Ti, In, Fe and Mn, or

M denotes a tetravalent axially disubstituted metal atom of the formula (1b), in which the metal Me is selected from the group consisting of Si, Ge, Sn, Zr, Cr, Ti, Co and V, are used.

X¹ and X² are particularly preferably halogen, in particular chlorine, aryloxy, in particular phenoxy, or alkoxy, in particular methoxy.

R³-R⁶ represent in particular halogen, C₁-C₆-alkyl or C₁-C₈-alkoxy.

Phthalocyanines of the formula I in which M represents a radical of the formula (1a) or (1b) are very particular preferred. Very particular preferred w, x, y and z each represent 0. X¹ and/or X² in formula (1a) or (1b) each denote halogen in a very particularly preferred way.

The phthalocyanines used according to the invention can be prepared by known methods, for example:

by synthesis of the nucleus from correspondingly substituted phthalodinitriles in the presence of the corresponding metals, metal halides or metal oxides,

by chemical modification of a phthalocyanine, for example by sulpho-chlorination or chlorination of phthalocyanines and further reactions, for example condensations or substitutions of the products resulting therefrom,

the axial substituents X¹ and X² are usually prepared from the corresponding halides by exchange.

The light-absorbing compound should preferably be thermally modifiable. Thermal modification is preferably effected at a temperature of <700° C. Such a modification may be, for example, decomposition, morphology change or chemical modification of the chromophoric centre of the light-absorbing compound.

The light-absorbing substances described guarantee a sufficiently high reflectivity of the optical data medium in the unrecorded state and sufficiently high absorption for the thermal degradation of the information layer during illumination at a point with focused blue light, in particular laser light, preferably having a light wavelength in the range from 360 to 460 nm. The contrast between recorded and unrecorded parts on the data medium is realized through the change in reflectivity in terms of the amplitude as well as the phase of the incident light as a result of the changed optical properties of the information layer after the recording. In particular the light absorbing substances guarantees a well defined shape of the readout signal with a drop of the reflectivity in the recorded mark.

In other words, the optical data medium can preferably be recorded on and read using laser light having a wavelength of 360-460 nm.

The coating with the phthalocyanines is preferably effected by spin-coating, sputtering or vacuum vapour deposition. By vacuum vapour deposition or sputtering, it is possible to apply in particular the phthalocyanines which are insoluble in organic or aqueous media, preferably those of the formula (1) in which w, x, y and z each denote 0 and M represents

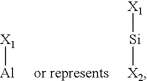

in which X₁ and X₂ have the abovementioned meaning.

In particular, the phthalocyanines which are soluble in organic or aqueous media are suitable for application also by spin-coating. The phthalocyanines can be mixed with one another or with other dyes having similar spectral properties. The information layer may contain additives, such as binders, wetting agents, stabilizers, diluents and sensitizers, and further components in addition to the phthalocyanines.

The merocyanine dyes are applied to the optical data carrier preferably by spin-coating or vacuum evaporation. The merocyanines can be mixed with each other or with other dyes having similar spectral properties. In addition to the merocyanine dyes the information layer can contain additives such as binders, wetting agents, stabilizers, diluents and sensitizers as well as other components.

The optical data store may carry further layers, such as metal layers, dielectric layers, barrier layers, and protective layers, in addition to the information layer. Metal and dielectric and/or barrier layers serve, inter alia, for adjusting the reflectivity and the heat balance. Metals may be gold, silver, aluminium, alloys, etc., depending on the laser wavelength. Dielectric layers are, for example, silica and silicon nitride. Barrier layers can be comprised of dielectric layers or metal layers. Protective layers are, for example, photocurable coats, melt adhesive layers, pressure sensitive adhesive layers and protective films.

Pressure sensitive adhesive layers in preferably composed of acrylic adhesives, for example, Nitto Denko DA-8320 or DA-83 10 fits for this usage as disclosed in JP-A 11-273147.

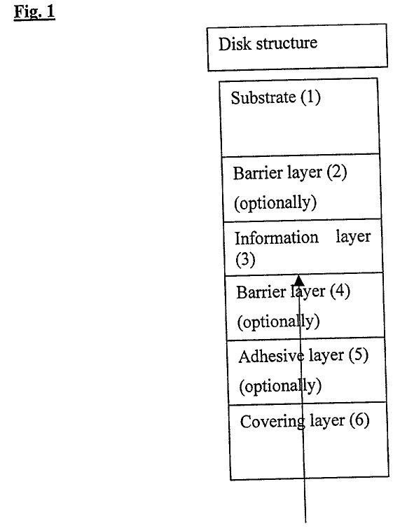

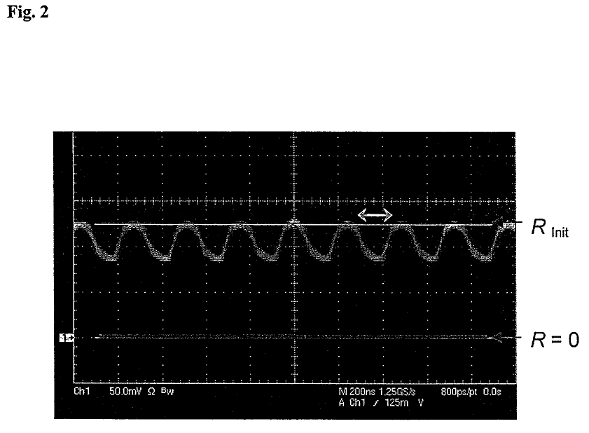

As shown in FIG. 1 the optical data store preferably contains a substrate (1), optionally a barrier layer (2), an information layer (3), optionally a further barrier layer (4), optionally an adhesive layer (5), and a cover layer (6).

Preferably, the structure of the optical data medium can:

contain a preferably transparent substrate (1) on the surface of which at least one information layer (3) which can be recorded on using light, optionally a barrier layer (4) and optionally an adhesive layer (5) and a covering layer (6) have been applied.

contain a preferably transparent substrate (1) on the surface of which optionally a barrier layer (2), at least one information layer (3) which can be recorded on using light, optionally an adhesive layer (5) and a transparent covering layer (6) have been applied.

contain a preferably transparent substrate (1) on the surface of which optionally a barrier layer (2), at least one information layer (3) which can be recorded on using light, optionally a barrier layer (4), optionally an adhesive layer (5) and a transparent covering layer (6) have been applied.

contain a preferably transparent substrate (1) on the surface of at least one information layer (3) which can be recorded on using light, optionally an adhesive layer (5) and a transparent covering layer (6) have been applied

The invention furthermore relates to optical data media according to the invention which can be recorded on using blue light, in particular laser light, particularly preferably laser light having a wavelength of 360-460 nm.

The following Examples illustrate the subject of the invention.

The invention furthermore relates to optical data media according to the invention which can be recorded on using blue light, in particular laser light, particularly preferably laser light having a wavelength of 360-460 nm.

The following Examples illustrate the subject of the invention.

### EXAMPLES

### Example 1

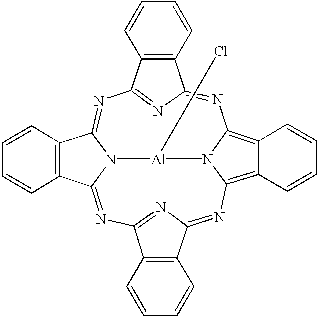

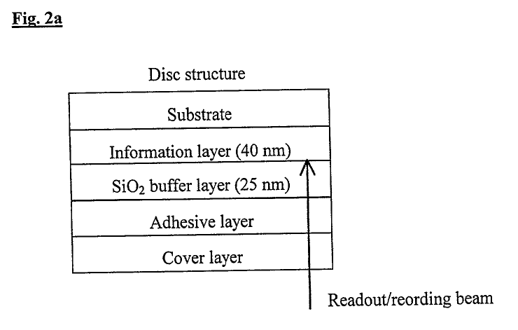

The dye monochloro-aluminium-phthalocyanine (AlClPc) was applied for the information layer. The disc structure employed was as shown in FIG. 2a.

The polycarbonate substrate was molded by injection method to form a groove structure of 0.64 μm picth and the depth of 40 nm. Directly on top of the grooved surface the information layer of 40 nm was coated by vacuum vapor deposition method. To prevent the information layer to diffuse into the adhesive layer, the information layer was covered with a SiO₂ buffer layer of 25 nm thickness by RF reactive sputtering method. A pressure sensitive adhesive (PSA; Nitto Denko DA/8320) was then applied as an adhesive layer and an additional cover layer (polycarbonate) on the incident beam side of the medium. Total thickness of the adhesive layer and the cover layer was set as 100 μm.

The parameters of readout/recording setup was as follows.

Wavelength of the laser=405 nm

Numerical aperture of the objective lens=0.85, two element lens

Readout laser power=0.30 mW

Writing laser power=6.0 mW

Line velocity of the disc rotation=5.72 m/s

Writing mark and space length=0.69 μm, periodic

Pulse strategy=7 pulses with 50% duty inside one mark

As a result, after recording on a groove track, a rectangular waveform was obtained as shown in the FIG. 2. Here R represents the reflectivity from the media, and R_{Init} represents the initial reflectivity. It is clearly seen in this figure that the recorded area showed uniformly lower reflectivity as it is desired. The carrier-to-noise ratio (C/N) was 48.4 dB at 30 kHz resolution band width (RBW). Although the information layer was covered only with thin SiO₂ buffer layer and soft PSA layer, its readout stability was surprisingly good, almost the same level as the CD-R or DVD-R media which comprises a UV resin hard cover. Similar result was also obtained when recording was performed on the land surface of the grooved structure.

### Example 2

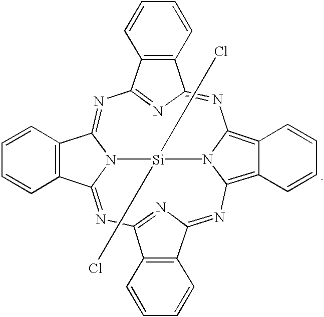

The dye dichloro-silicon-phthalocyanine (SiCl₂Pc) was applied for the information layer. The disc structure employed was identical to example 1, except the SiO₂ thickness, which was set as 40 nm. Recording condition was also identical to the example 1.

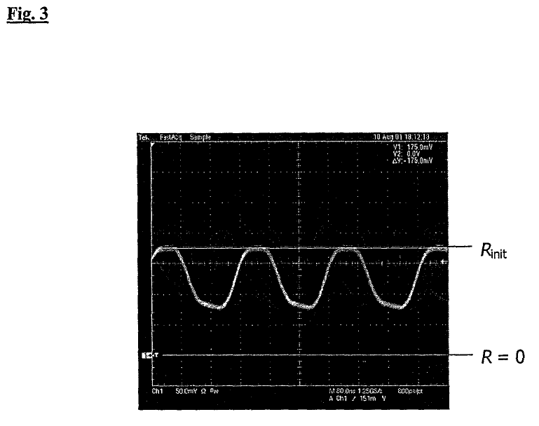

The result shows that the rectangular waveform was clearly recorded in this media with very low noise and high modulation ratio (FIG. 3). The carrier-to-noise ratio was 55 dB at 30 kHz RBW. Distortion of the readout marks was very small that it is clear that the combination of this dye and the layer structure matched to such media format and the optical pick-up parameters. Also, it showed a very high readout stability. Up to 0.7 mW of readout power, the C/N level remained at this high level.

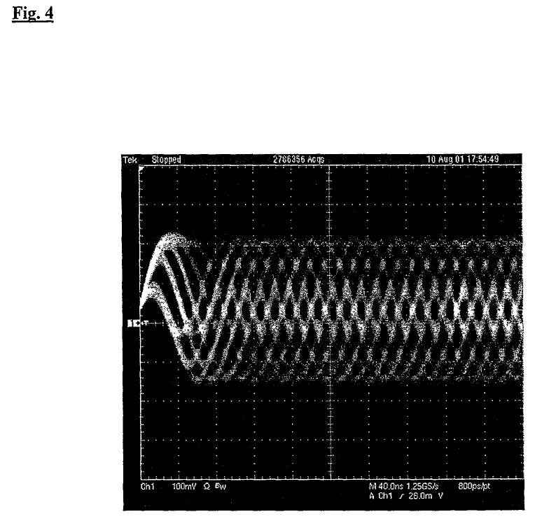

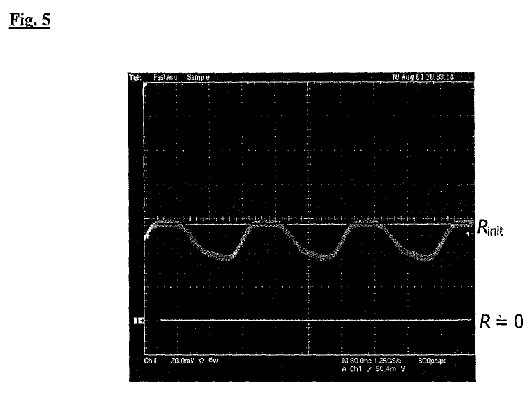

According to its high performance of the recording and readout stability, this media showed excessively high potential for the high density recording. A random pattern recording with (1,7) RLL modulation was performed with the smallest mark length of 0.173 μm. The data capacity on a single side 12 cm diameter disc will correlate to 21 GB, when it is recorded both on land and in groove. A clear eye pattern on land recording was obtained as shown in the FIG. 4, with its jitter level of 10%. Similar result was obtained in groove, thus it showed its potential for over 21 GB capacity on a single-sided disc.

### Example 3

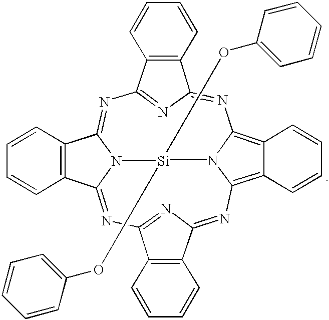

The above dye was applied for the information layer. The disc structure and the recording parameters are identical to example 2. Similar to example 1 and example 2, it showed a rectangular waveform with high readout stability (FIG. 5). The C/N level was 45 dB with 30 kHz resolution band width.

In a similar way the dyes of example 3-23 can be used.

### Examples 3-23

(MeX₁X₂)PcR³R⁴R⁵R⁶

| Nr. | Me | X₁ | X₂ | R³ | R⁴ | R⁵ | R⁶ |
|---|---|---|---|---|---|---|---|
| 4 | Al | O—C₆H₅ | — | — | — | — | — |
| 5 | Zn | — | — | — | — | — | — |
| 6 | V | ═O | — | — | — | — | — |
| 7 | Ga | Cl | — | — | — | — | — |
| 8 | In | Cl | — | — | — | — | — |
| 9 | Ge | Cl | Cl | — | — | — | — |
| 10 | Si | OCH₂CH₃ | OCH₂CH₃ | — | — | — | — |
| 11 | Si | CH₃ | Cl | — | — | — | — |
| 12 | Si | Phenyl | Cl | — | — | — | — |
| 13 | Si | CH₃ | OCH₂CH₃ | — | — | — | — |
| 14 | Si | OSi(CH₃)₃ | OSi(CH₃)₃ | — | — | — | — |
| 15 | Si | Cl | Cl | C(CH₃)₃ | C(CH₃)₃ | — | — |
| 16 | Si | Cl | Cl | C(CH₃)₃ | C(CH₃)₃ | C(CH₃)₃ | C(CH₃)₃ |
| 17 | Al | Cl | — | C(CH₃)₃ | C(CH₃)₃ | C(CH₃)₃ | C(CH₃)₃ |
| 18 | Al | OH | — | — | — | — | — |
| 19 | Al | Cl | — | Si(CH₃)₃ | Si(CH₃)₃ | Si(CH₃)₃ | Si(CH₃)₃ |
| 20 | Ti | OSi(CH₃)₃ | OSi(CH₃)₃ | — | — | — | — |
| 21 | Sn | OSi(CH₃)₃ | OSi(CH₃)₃ | — | — | — | — |
| 22 | Zr | OSi(CH₃)₃ | OSi(CH₃)₃ | — | — | — | — |
| 23 | Ru | OCH₂CH₃ | OCH₂CH₃ | — | — | — | — |

### Example 24

2.1 g of 1-butyl-3-cyano-4-methyl-6-hydroxy-2-pyridone and 2.0 g of 1,3,3-trime-thylindole-2-methylene-ω-aldehyde were stirred into 5 ml of acetic anhydride for 2 hours at 90° C. After cooling, the mixture was discharged onto 100 ml of iced water, filtered off with suction and the residue washed with water. It was then stirred into 20 ml of water/methanol 3:1, filtered off with suction and dried. 3.3 g (85% of theory) of a red powder of the formula

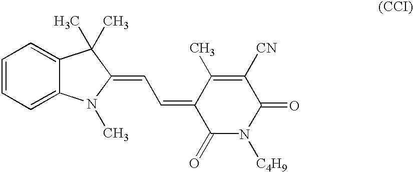

were obtained.

M.p.=249-251° C.

UV (dioxane): λₘₐₓ=520 nm

UV (DMF): λₘₐₓ=522 nm

ε=113100 l/mol cm

Δλ=2 nm

λ_{½}-λ_{1/10} (longwave slope)=12 nm

Solubility: >2% in TFP (2,2,3,3-tetrafluoropropanol).

### Example 25

Following the same procedure 2.6 g (79% of theory) of a red powder of the formula

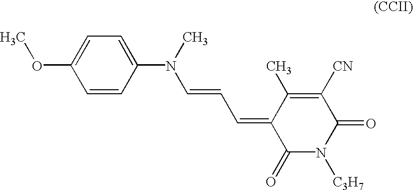

were obtained using 1.7 g of 1-propyl-3-cyano-4-methyl-6-hydroxy-2-pyridone and 1.7 g of N-methyl-N-(4-methoxyphenyl)-acrolein.

M.p. =206-216° C.

UV (dioxane): λₘₐₓ=482 nm

UV (DMF): λₘₐₓ=477 nm

ε=73013 l/mol cm

Δλ=5 nm

λ_{½}-λ_{1/10} (shortwave slope)=33 nm

Solubility: >2% in TFP.

### Example 26

2,03 g of 3-pyridinio-4-methyl-6-hydroxy-pyridone chloride and 2,0 g of 1,3,3-trime-thylindole-2-methylene-ω-aldehyde were stirred into 10 ml of acetic anhydride for 2 hours at 90° C. After cooling, the mixture was discharged onto 200 ml of water. 2.8 g of sodium tetrafluoroborate were added to the orange solution. After stirring the mixture overnight it was filtered off with suction and the residue was washed with 20 ml of water and dried. 3.3 g (74% of theory) of a reddish orange powder of the formula

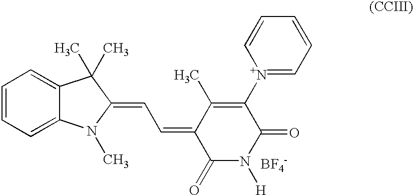

were obtained.

M.p. >300° C.

UV (methanol): λₘₐₓ=513 nm

ε=86510l/mol cm

λ_{½}-λ_{1/10} (shortwave slope)=38 nm

Solubility: >2% in TFP.

### Example 27

0,7 g of 5-dimethylaminofuran-2-carbaldehyde and 1.5 g of N-methyl-N′-dodecyl-barbituric acid were stirred into 15 ml of acetic anhydride for 30 mins. at 90° C. After cooling, the mixture was discharged onto 100 ml of iced water, filtered off with suction and the residue washed with water. 1.7 g (79% of theory) of an orange powder of the formula

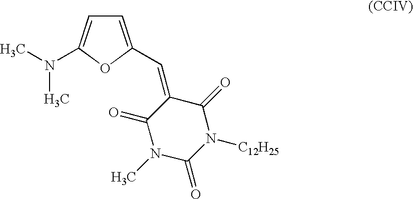

was obtained.

M.p. 118-120° C.

UV (dioxane): λₘₐₓ=483 nm

ε=53360 l/mol cm

λ_{½}-λ_{1/10} (shortwave slope)=32 nm

Solubility: >1% in benzyl alcohol.

Other examples according to the invention are summarized in the following tables:

TABLE 1
(Formula (VI)

| Ex. | 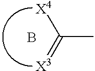 | Y¹ | ═CX¹X² | λₘₐₓ¹⁾/ nm | ε/l/ mol cm | λ_{1/2}-λ_{1/10}/ nm | Δλ²⁾/nm |
|---|---|---|---|---|---|---|---|
| 28 | 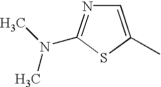 | C—CN | ═C(CN₂) | 470 | 40990 | 32³⁾ | 16 |
| 29 | 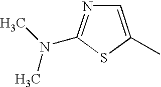 | CH | 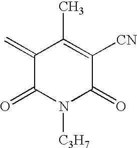 | 502 | 62860 | 33³⁾ | |
| 30 | 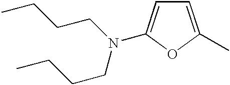 | CH | 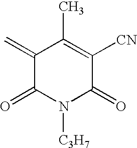 | 539 | 146480 | 18⁴⁾ | 1.5 |
| 31 | 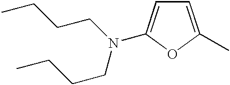 | CH | 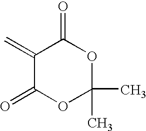 | 472 | 70880 | 32³⁾ | 5 |
| 32 | 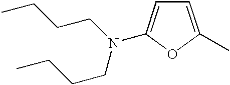 | CH | 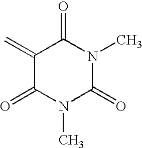 | 490 (DMF) | | | |
| 33 | 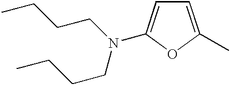 | CH | 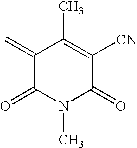 | 539 | 106640 | | |
| 34 | 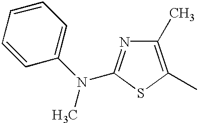 | CH | 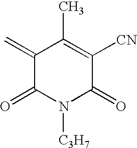 | | | | |
| 35 | 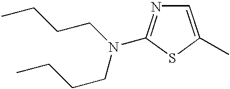 | CH | 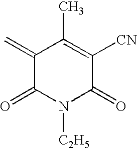 | 508 | 78400 | | |
| 36 | 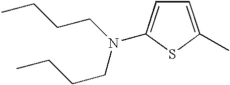 | CH | 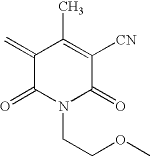 | 536 | 112260 | | |
| 37 | 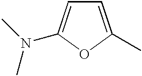 | CH | 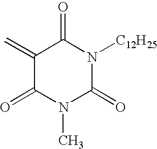 | 483 | 53360 | | |
| 38 | 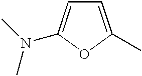 | CH | 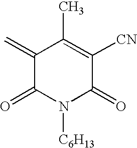 | 535 | 128960 | | 1.3 |
| 39 | 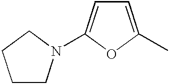 | CH | 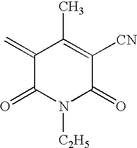 | 536 (DMF) | 115603 | | 2 |
| 40 | 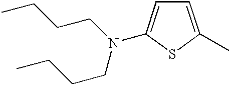 | CH | 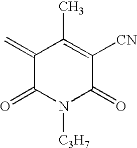 | 535 | 112260 | 13⁴⁾ | |
| 41 | 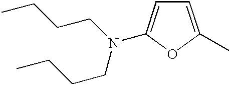 | CH | 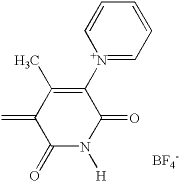 | | | | |
| 42 | 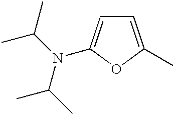 | CH | 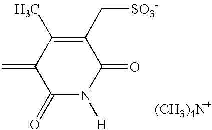 | | | | |
| 43 | 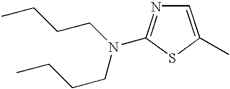 | N | 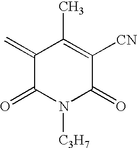 | | | | |
| 44 | 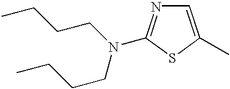 | C—CN | ═C(CN)₂ | | | | |
| 45 | 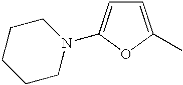 | CH | 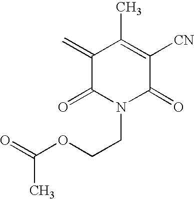 | | | | |
| 46 | 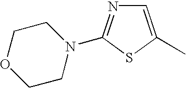 | CH | 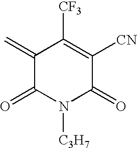 | | | | |
| 47 | 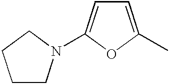 | CH | 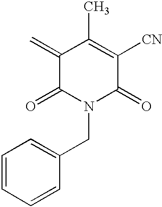 | | | | |
| 48 | 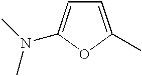 | CH | 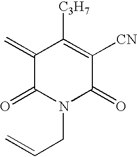 | | | | |
| 49 | 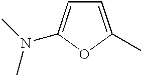 | CH | 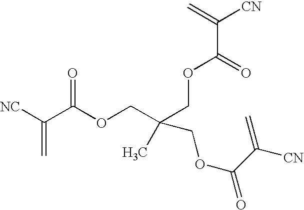 | 455 | | | |
| 50 | 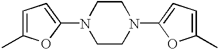 | CH | 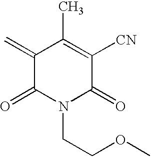 | 538 | | | |
| 51 | 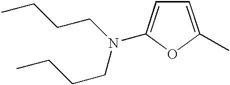 | CH | 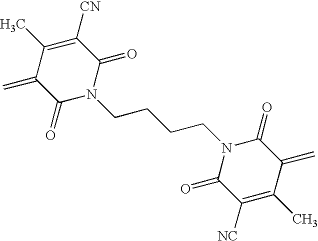 | 537 | 132860 | | |
| 52 | 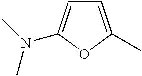 | CH | 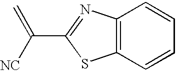 | 490 | 35000 | 40³⁾ | 23 |
| 53 | 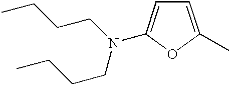 | CH | 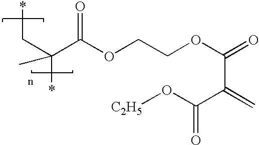 | 431 (DMF) | | | |
| 54 | 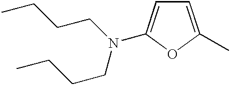 | CH | 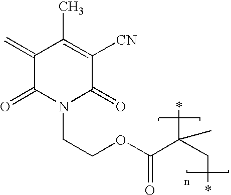 | 536 (DMF) | | | |
| 55 | 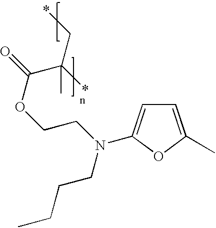 | CH | 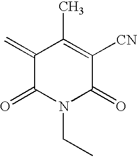 | 536 (DMF) | | | |

¹⁾in dioxane, unless indicated otherwise
²⁾= |λ_{DMF} − λ_{dioxane}|
³⁾on the shortwave slope
⁴⁾on the longwave slope

TABLE 2
(Formula (VII)

| Ex. | 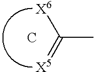 | Y²—Y¹ | ═CX¹X² | λₘₐₓ¹⁾/ nm | ε/l/ mol cm | λ_{1/2}-λ_{1/10}/ nm | Δλ²⁾/nm |
|---|---|---|---|---|---|---|---|
| 56 | 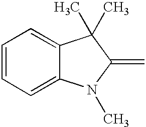 | CH—C(CN) | ═C(CN)₂ | 499 | 46470 | 36³⁾ | 5 |
| 57 | 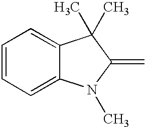 | CH—CH | 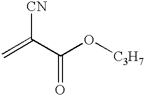 | 429 | 60390 | 30³⁾ | 7 |
| 58 | 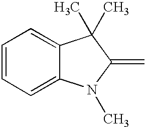 | CH—CH | 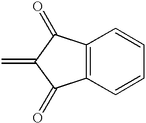 | 487 | 102220 | 35³⁾ | 6 |
| 59 | 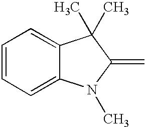 | CH—CH | 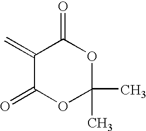 | 448 | 76260 | 27³⁾ | 2 |
| 60 | 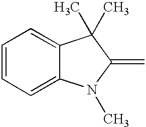 | CH—CH | 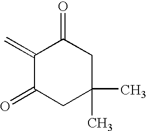 | 469 | 76130 | 28³⁾ | 3 |
| 61 | 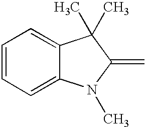 | CH—CH | 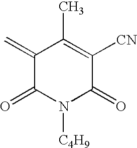 | 520 | 113100 | 12⁴⁾ | 2 |
| 62 | 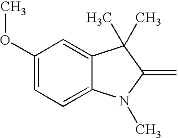 | CH—C(CN) | ═C(CN)₂ | 511 | 31345 | 36³⁾ | 6 |
| 63 | 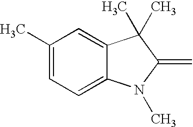 | CH—C(CN) | ═C(CN)₂ | 503 | 41530 | 36³⁾ | 6 |
| 64 | 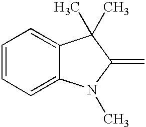 | CH—CH | 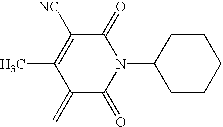 | 519 | 55910 | 11⁴⁾ | |
| 65 | 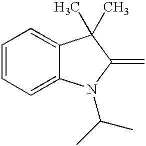 | CH—CH | 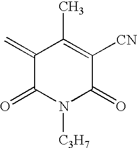 | | | | |
| 66 | 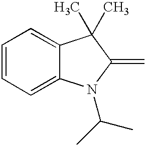 | CH—CH | 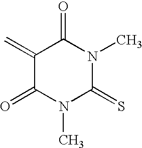 | 486 | 115091 | | |
| 67 | 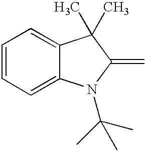 | CH—CH | 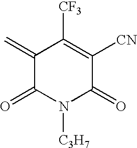 | | | | |
| 68 | 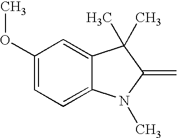 | CH—CH | 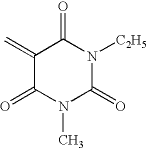 | | | | |
| 69 | 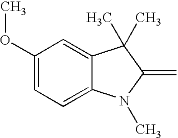 | CH—CH | 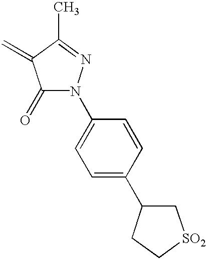 | 473 | 47640 | | |
| 70 | 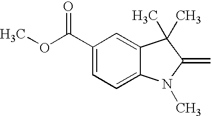 | CH—CH | 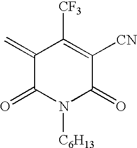 | | | | |
| 71 | 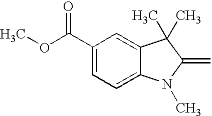 | CH—CH | 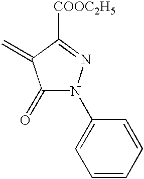 | 496 | 62720 | | |
| 72 | 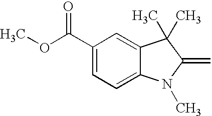 | CH—CH | 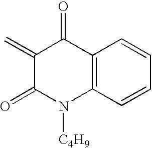 | 500 | 110332 | | |
| 73 | 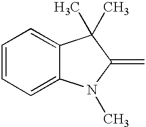 | CH—CH | 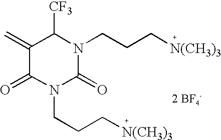 | | | | |
| 74 | 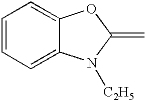 | CH—CH | 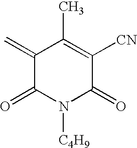 | 490 (DMF) | 109380 | | 5 |
| 75 | 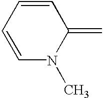 | CH—CH | 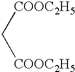 | 450 | | | |
| 76 | 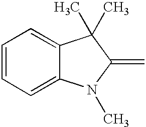 | CH—CH | 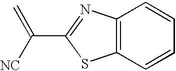 | 462 | 57230 | 34³⁾ | |
| 77 | 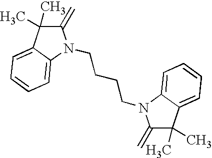 | CH—C(CN) | ═C(CH)₂ | 500 | | | |
| 78 | 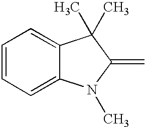 | CH—CH | 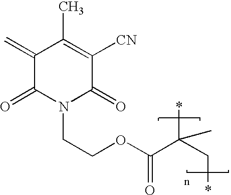 | 521 (DMF) | | | |

¹⁾in dioxane, unless indicated otherwise
²⁾= |λ_{DMF} − λ_{dioxane}|
³⁾on the shortwave slope
⁴⁾on the longwave slope

TABLE 3
(Formula (VIII)

| | | | | λₘₐₓ¹⁾/ | ε/l/ | λ_{1/2}-λ_{1/10}/ | |
|---|---|---|---|---|---|---|---|
| Ex. | NR⁹R¹⁰ | Y¹ | ═CX¹X² | nm | mol cm | nm | Δλ²⁾/nm |
| 79 | 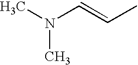 | CH | 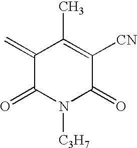 | 462 | 77180 | 28³⁾ | 8 |
| 80 | 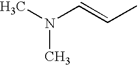 | CH | 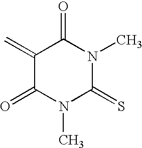 | | | | |
| 81 | 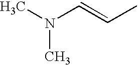 | CH | 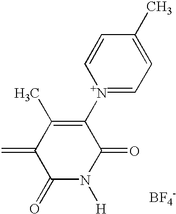 | | | | |
| 82 | 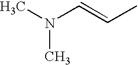 | CH | 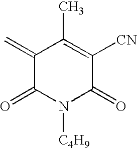 | 918 (DMF) | 89100 | | |
| 83 | 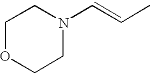 | CH | 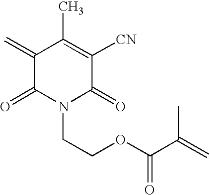 | 458 | 89800 | 28³⁾ | |
| 84 | 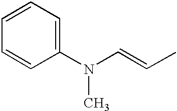 | CH | 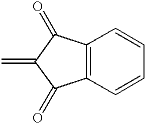 | 447 | 84070 | | |
| 85 | 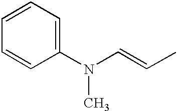 | CH | 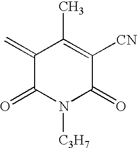 | 480 | 79685 | | 1.3 |
| 86 | 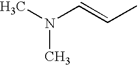 | CH | 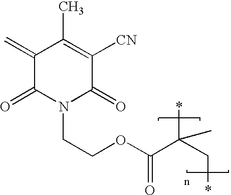 | 453 (DMF) | | | |

¹⁾in dioxane, unless indicated otherwise
²⁾= |λ_{DMF} − λ_{dioxane}|
³⁾on the shortwave slope
⁴⁾on the longwave slope

### Example 87

The dye shown above in example 76, which has the formula

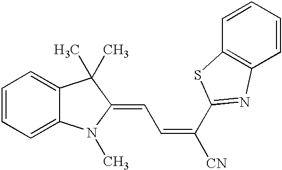

was applied for the information layer. The disc structure employed was as shown in FIG. 2a.

The polycarbonate substrate was molded by injection method to form a groove structure of 0.64 m pitch and the depth of 40 nm. Directly on top of the grooved surface the information layer was coated by spin-coating method. The parameters for spin-coating were as follows.

| | |
|---|---|
| Solvent: | Tetrafluoropropanol (TFP) |
| Solution: | 1.0 wt.% |
| Disc rotation speed for coating the solvent: | 220 rpm, 12 seconds |
| Disc rotation speed for spin off and drying: | 1200 rpm, 30 seconds |

Thickness of the dye layer in groove and on land was 80 nm and 60 nm respectively. To prevent the information layer to diffuse into the adhesive layer, the information layer was covered with a SiN buffer layer of 40 nm thickness by RF reactive sputtering method. A pressure sensitive adhesive (PSA; Nitto Denko DA/8320) was then applied as an adhesive layer and an additional cover layer (polycarbonate) on the incident beam side of the medium. Total thickness of the adhesive layer and cover layer was set as 100 μm.

The parameters of readout/recording set-up were as follows.

Wavelength of the laser=404 nm

Numerical aperture of the objective lens=0.85, two element lens

Readout laser power=0.30 mW

Writing laser power=6.0 mW

Line velocity of the disc rotation=5.72 m/s

Writing mark and space length=0.69 μm, periodic

Pulse strategy=7 pulses with 50% duty inside one mark

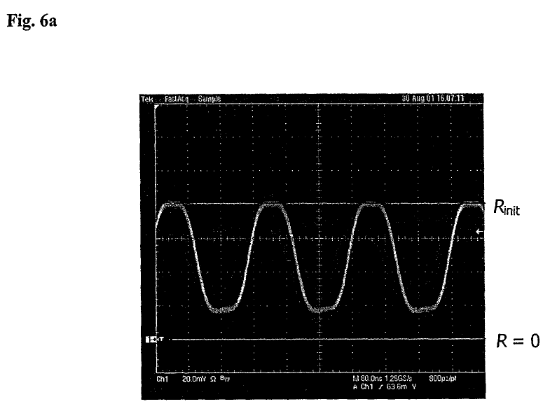

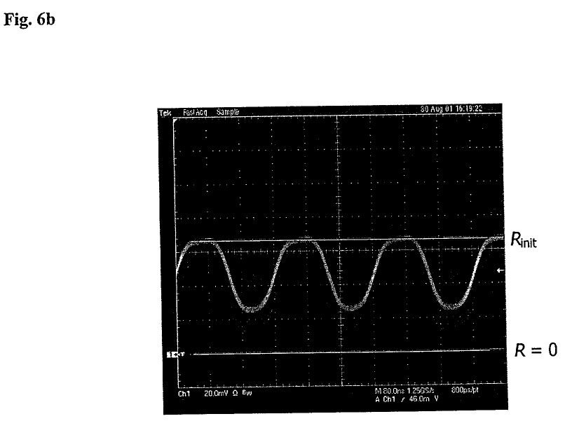

As a result, after recording on a groove track, a clear rectangular waveform was obtained as shown in the FIG. 6a and 6b for groove and land area respectively. Here R represents the reflectivity from the media, and R_{Init} represents the initial reflectivity. It is clearly seen in this figure that the recorded area showed uniformly lower reflectivity as it is desired. The carrier-to-noise ratio (C/N) measurement was performed using Takeda Riken TR4171, resulting in 57.4 dB and 53.0 dB for groove and land respectively at 30 kHz resolution band width (RBW). These high C/N prove its high performance for high density recording, since this media was recordable on both land/groove, which lead to practically a doubled track pitch, namely 0.32 μm. Also, point to be noted is that the modulation ratio (reflectivity from the marks/R_{Init}) was reaching almost 80%. With such huge modulation ratio, this media presents an ideal signal quality and ultimate carrier level.

Additionally, a small mark recording was performed with the parameters as follows.

Writing mark and space length=0.17 m, periodic

Pulse strategy=1 pulse inside one mark

Other conditions are identical to 0.69 μm mark recording.

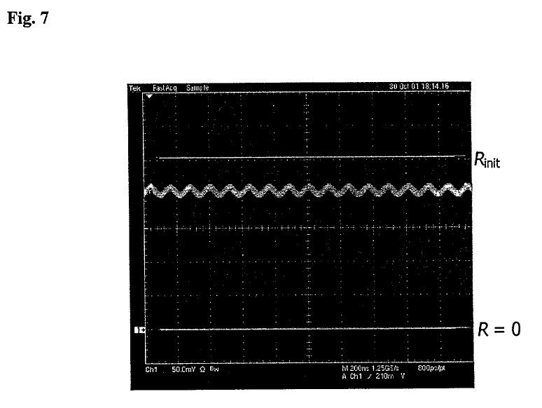

As a result, a clear waveform was observed as shown in FIG. 7. The modulation amplitude is smaller than FIG. 6a or 6b, however, it is close to a theoretical value for such a small mark near the cut-off frequency of the readout optics. The C/N value for this readout signal was 40.0 dB. Using the mark length of 0.17 μm as a smallest mark of (1,7) RLL modulation, the capacity for a 12 cm diameter single-sided disc reaches 21 GB. This dye showed its possibility for such a high density recording.

1. Optical data medium containing a preferably transparent substrate which is optionally already coated with one or more barrier layers and on the surface of which an information layer which can be recorded on using light, optionally one or more barrier layers, and a cover layer, have been applied, which data medium can be recorded on and read using focused blue light through the cover layer on the information layer, preferably laser light with the wavelength between 360 nm and 460 nm, the information layer containing a light-absorbing compound and optionally a binder, characterized in that at least one dye is used as the light-absorbing compound wherein the cover layer on the top of the information layer including the adhesive layer do have a total thickness of 10 μm to 177 μm and the numerical aperture NA of the focusing objective lens setup is greater or equal 0.8.

2. Optical data medium according to claim 1, wherein the dye used as the light absorbing compound is a phthalocyanine or a napthalocyanine, where in both cases the aromatic rings also may be heterocycles.

3. Optical data medium according to claim 1, wherein the dye used as the light absorbing compound is a merocyanine dye.

4. Optical data medium according to claim 1, wherein the barrier layers on top of the information layer at least contain one dielectric layer.

5. Optical data medium according to claim 1, wherein the barrier layers contain a dielectric layer directly on top of the information layer and a pressure sensitive adhesive layer on the dielectric layer and a top cover layer thereover.

6. Optical data medium according to claim 1 wherein the top cover layer is a polycarbonate, a copolycarbonate, a polycycloolefine or polyolefine.

7. Optical data medium according to claim 1, characterized in that the dye corresponds to the formula (I)
MPc[R³]_{w}[R⁴]ₓ[R⁵]_{y}[R⁶]_{z} (I),
in which
Pc represents a phthalocyanine or a naphthalocyanine, where in both cases the aromatic rings also may be heterocycles,
M represents two independent H atoms, represents a divalent metal atom or represents a trivalent axially monosubstituted metal atom of the formula (Ia) 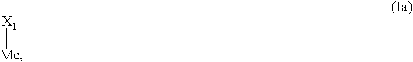
or represents a tetravalent axially disubstituted metal atom of the formula (Ib) 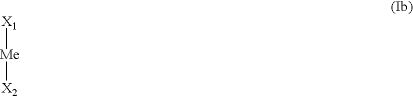
or represents a trivalent axially monosubstituted and axially monocoordinated metal atom of the formula (Ic) 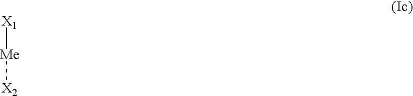
where, in the case of a charged ligand or substituent X₁ or X₂, the charge being compensated by an opposite ion and
the radicals R³ to R⁶ corresponding to substituents of the phthalocyanine,
X¹ and X², independently of one another, represent halogen, hydroxyl, oxygen, cyano, thiocyanato, cyanato, alkenyl, alkinyl, arylthio, dialkylamino, alkyl, alkoxy, acyloxy, alkylthio, aryl, aryloxy, —O—SO₂R⁸, O—PR¹⁰R¹¹, —O—P(O)R¹²R¹³, —O—SiR¹⁴R¹⁵R¹⁶, NH₂, alkylamino and the radical of a heterocyclic amine,
R³, R⁴, R⁵ and R⁶, independently of one another, represent halogen, cyano, nitro, alkyl, aryl, alkylamino, dialkylamino, alkoxy, alkylthio, aryloxy, arylthio, SO₃H, SO₂NR¹R², CO₂R⁹, CONR¹R², NH—COR⁷ or a radical of the formula —(B)ₘ—D, in which
B denotes a bridge member from the group consisting of a direct bond, CH₂, CO, CH(alkyl), C(alkyl)₂, NH, S, O or —CH═CH—, (B)ₘ denoting a chemically reasonable sequence of bridge members B with m=1 to 10, m preferably being 1, 2, 3 or 4,
D represents the monovalent radical of a redox system of the formula 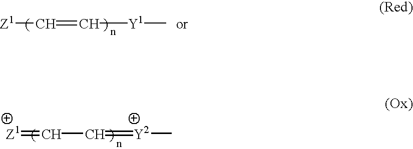
or represents a metallocenyl radical or metallocenylcarbonyl radical, titanium, manganese, iron, ruthenium or osmium being suitable as the metal centre,
Z¹ and Z², independently of one another, represent NR′R″, OR″ or SR″,
Y¹ represents NR′, O or S, Y² represents NR′,
n represents 1 to 10 and
R′ and R″, independently of one another, represent hydrogen, alkyl, cycloalkyl, aryl or hetaryl, or form a direct bond or a bridge to one of the C atoms of the 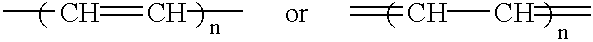
chain,
w, x, y and z, independently of one another, represent 0 to 4 and w+x+y+z ≦16,
R¹and R², independently of one another, represent alkyl, hydroxyalkyl or aryl or R¹ and R², together with the N atom to which they are bonded, form a heterocyclic 5-, 6- or 7-membered ring, optionally with participation of further hetero atoms, in particular from the group consisting of O, N and S, NR¹R² representing in particular pyrrolidino, piperidino or morpholino,
R⁷ and R¹⁶, independently of one another, represent alkyl, aryl, hetaryl or hydrogen.

8. Optical data media according to claim 7, characterized in that
M represents two independent H atoms or represents a divalent metal atom from the group consisting of Cu, Ni, Zn, Pd, Pt, Fe, Mn, Mg, Co, Ru, Ti, Be, Ca, Ba, Cd, Hg, Pb and Sn or represents a trivalent axially monosubstituted metal atom of the formula (Ia) in which Me represents Al, Ga, Ti, In, Fe or Mn or represents a tetravalent metal atom of the formula (Ib) in which Me represents Si, Ge, Sn, Zn, Cr, Ti, Co or V.

9. Optical data media according to claim 2, characterized in that
M represents a radical of the Formula (Ia) or (Ib), in which Me represents Al or Si,
X₁ and X₂ represent halogen, in particular chlorine, aryloxy, in particular phenoxy, or alkoxy, in particular methoxy, and
w, x, y and z each represent 0.

10. Optical data medium according to claim 1, wherein the light absorbing compound is a merocyanine.

11. Optical data medium according to claim 1, wherein the light absorbing compound corresponds to formula (1) 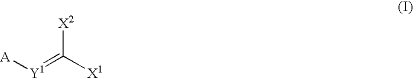
is preferred, wherein
A represents a radical of the formula 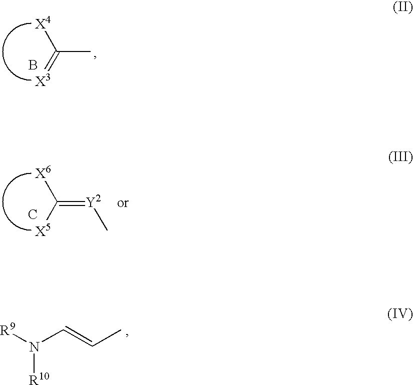
X¹ represents CN, CO—R¹, COO—R², CONHR³ or CONR³R⁴,
X² represents hydrogen, C₁- to C₆-alkyl, C₆- to C₁₀-aryl, a five- or six-membered heterocyclic radical, CN, CO—R¹, COO—R², CONHR³ or CONR³R⁴ or
CX¹X² represents a ring of the formulae 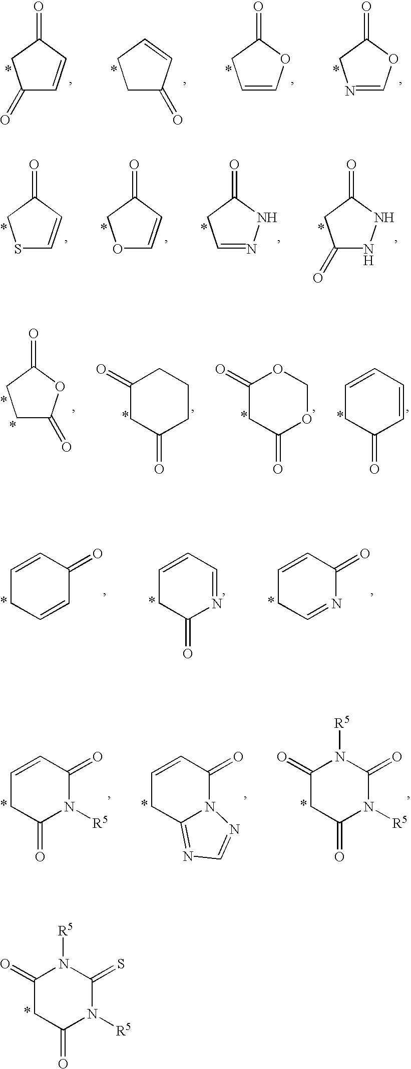
which can be benzo- or naphtha-fused and/or substituted by non-ionic or ionic radicals and wherein the asterisk (*) indicates the ring atom from which the double bond emanates,
X³ represents N or CH,
X⁴ represents O, S, N, N—R⁶ or CH, wherein X³ and X⁴ do not simultaneously represent CH,
X⁵ represents O, S or N—R⁶,
X⁶ represents O, S, N, N—R⁶, CH or CH₂,
the ring B of the formula (II) 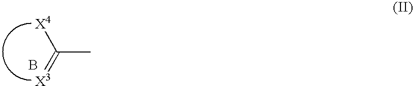
together with X⁴, X³ and the C atom bound therebetween
and the ring C of the formula (V) 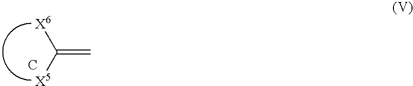
together with X⁵, X⁶ and the C atom bound therebetween independently of one another represent a five- or six-membered aromatic or quasiaromatic heterocyclic ring which can contain 1 to 4 hetero atoms and/or can be benzo- or naphtha-fused and/or substituted by non-ionic or ionic radicals,
Y¹ represents N or C—R⁷,
Y² represents N or C—R⁸,
R¹to R⁶ independently of one another represent hydrogen, C₁ to C₆-alkyl, C₃ to C₆-alkenyl, C₅ to C₇-cycloalkyl, C₆- to C₁₀-aryl or C₇ to C₁₅-aralkyl,
R⁷ and R⁸ independently of one another represent hydrogen, cyano or C₁ to C₆-alkyl,
R⁹ and R¹⁰ independently of one another represent C₁ to C₆-alkyl, C₆ to C₁₀-aryl or C₇ to C₁₅-aralkyl or
NR⁹R¹⁰ represents a 5- or 6-membered saturated heterocyclic ring.

12. Process for the production of the optical data media according to claim 1, which is characterized in that a preferably transparent substrate optionally already coated with a barrier layer is coated with the dye, optionally in combination with suitable binders and additives and optionally suitable solvents, and is optionally provided with a barrier layer, further intermediate layers and a cover layer applied by an adhesive layer.

13. Process for the production of the optical data media according to claim 1, characterized in that the coating with the dye is effected by means of spin-coating, sputtering or vapour deposition.

14. Optical data media having a recordable information layer, obtainable by recording on optical data media according to claim 1 using blue light, preferably laser light, in particular laser light having a wavelength of 360-460 nm.
